(19) United States
(12) Patent Application Publication
(10) Pub. No.: US 2020/0241401 A1
(43) Pub. Date: Jul. 30, 2020

(54) PROJECTION VIDEO DISPLAY APPARATUS

(71) Applicant: MAXELL, LTD., Kyoto (JP)

(72) Inventors: Kentaro SANO, Kyoto (JP); Takeshi KATAYAMA, Kyoto (JP)

(21) Appl. No.: 16/606,794

(22) PCT Filed: Apr. 27, 2017
(86) PCT No.: PCT/JP2017/016787

§ 371 Date: Oct. 21, 2019

(51) Int. Cl. G03B 21/16; G03B 21/20; F04D 13/12; H04N 9/31

(52) U.S. Cl. CPC G03B 21/16; G03B 21/2013; G03B 21/2033; H04N 9/3144; F04D 13/12

(57) ABSTRACT

A projection video display apparatus capable of, even when an air inlet of a certain duct among a plurality of ducts is blocked, securing a cooling air path to the duct whose air inlet is blocked is provided. A projection video display apparatus 100 according to one embodiment includes a heat generating member that generates heat such as an optical system component or an electronic component, a plurality of cooling fans 121 to 127 configured to cool heat from the heat generating member, and a plurality of ducts 201 to 203 to be cooling air paths each having at least one of the plurality of cooling fans 121 to 127 stored therein, at least two of the ducts being adjacent to each other. Also, the ducts adjacent to each other have openings 221 to 223 in wall surfaces between the adjacent ducts.

### TECHNICAL FIELD

The present invention relates to a projection video display apparatus, for example, a technology effectively applied to a projection video display apparatus in which a heat generating member including a light source that generates heat such as an optical system component or an electronic component is cooled.

### BACKGROUND ART

In a projection video display apparatus (hereinafter, referred to as “projector” in some cases) configured to project video onto a screen or the like, an LED (Light Emitting Diode) has been used as a light source in recent years. Since the rise in temperature of the LED to a prescribed temperature or higher leads to the decrease in lifetime, it is necessary to control the temperature of the LED to an appropriate temperature or lower.

For example, the Patent Document 1 describes a technology of providing a cooling mechanism configured to send a cooling air flow to a radiator thermally coupled to an LED in a projection video display apparatus using the LED as a light source. Also, the Patent Document 2 describes a technology in which air taken from outside is directed through a duct and blown to a lamp in a projection display apparatus using the lamp as a light source.

### RELATED ART DOCUMENTS

### Patent Documents

Patent Document 1: Japanese Patent Application Laid-Open Publication No. 2011-154855

Patent Document 2: Japanese Patent Application Laid-Open Publication No. 2005-31549

### SUMMARY OF THE INVENTION

### Problems to be Solved by the Invention

For example, the projection video display apparatus using an LED as a light source is sometimes installed at a place where an air inlet through which air for cooling the LED is taken is blocked. Since the air inlet is blocked in such a case, the temperature of the LED rises during the operation of the apparatus, and the lifetime of the LED is decreased when the temperature reaches a prescribed temperature or higher. Therefore, it is necessary to control the temperature of the LED to an appropriate temperature or lower even when the air inlet is blocked.

In particular, in the structure provided with a plurality of LEDs and a plurality of ducts serving as cooling air paths corresponding to each of the LEDs, the decrease in lifetime of the LED becomes remarkable. For example, when the air inlet of the duct corresponding to a certain LED among the plurality of LEDs is blocked, it is not possible to cool the LED and the lifetime of the LED is decreased more rapidly than the other LEDs, resulting in the significant decrease in the lifetime of the overall apparatus.

Note that the Patent Document 1 mentioned above does not describe the structure provided with a duct. Also, although the Patent Document 2 mentioned above is provided with a plurality of ducts, it does not consider the case where the air inlet of the duct is blocked.

Thus, an object of the present invention is to provide a projection video display apparatus capable of, even when an air inlet of a certain duct among a plurality of ducts is blocked, securing a cooling air path to the duct whose air inlet is blocked.

The above and other objects and novel feature of the present invention will be apparent from the descriptions of this specification and the accompanying drawings.

### Means for Solving the Problems

The following is a brief description of an outline of the typical invention disclosed in the present application.

A projection video display apparatus according to one embodiment includes: a heat generating member that generates heat such as an optical system component or an electronic component; a plurality of cooling fans configured to cool heat from the heat generating member; and a plurality of ducts to be cooling air paths each having at least one of the plurality of cooling fans stored therein, at least two of the ducts being adjacent to each other. Also, the ducts adjacent to each other have an opening in a wall surface between the adjacent ducts.

### Effect of the Invention

The effect obtained by a typical invention disclosed in the present application will be briefly described below.

According to an embodiment, it is possible to provide a projection video display apparatus capable of, even when an air inlet of a certain duct among a plurality of ducts is blocked, securing a cooling air path to the duct whose air inlet is blocked.

### BRIEF DESCRIPTIONS OF THE DRAWINGS

FIG. 1 is a perspective view on a front side showing an example of an internal layout of a projection video display apparatus according to an embodiment of the present invention;

FIG. 2 is a perspective view on a back side showing the example of the internal layout of the projection video display apparatus according to the embodiment of the present invention;

FIG. 3 is an exploded perspective view on the back side showing FIG. 2 in an exploded manner;

FIG. 4 is an exploded perspective view on the back side showing FIG. 3 in an exploded manner;

FIG. 5 is an exploded perspective view on the back side showing FIG. 2 in an exploded manner;

FIG. 6 is a perspective view on the back side showing the example of the internal layout for describing each cross section in the perspective view of FIG. 2;

FIG. 7 is a cross-sectional view showing a cross section A of FIG. 6;

FIG. 8 is a cross-sectional view showing a cross section B of FIG. 6;

FIG. 9 is a cross-sectional view showing a cross section C of FIG. 6;

FIG. 10 is an explanatory diagram showing an example of a basic structure for cooling in the projection video display apparatus according to the embodiment of the present invention;

FIG. 11 is an explanatory diagram showing a cooling structure example 1 in the projection video display apparatus according to the embodiment of the present invention;

FIG. 12 is an explanatory diagram showing a cooling structure example 2 in the projection video display apparatus according to the embodiment of the present invention;

FIG. 13 is an explanatory diagram showing a cooling structure example 3 in the projection video display apparatus according to the embodiment of the present invention;

FIG. 14 is an explanatory diagram showing a cooling structure example 4 in the projection video display apparatus according to the embodiment of the present invention;

FIG. 15 is an explanatory diagram showing a cooling structure example 5 in the projection video display apparatus according to the embodiment of the present invention;

FIG. 16 is an explanatory diagram showing a cooling structure example 6 in the projection video display apparatus according to the embodiment of the present invention;

FIG. 17 is an explanatory diagram showing a cooling structure example 7 in the projection video display apparatus according to the embodiment of the present invention;

FIG. 18 is an explanatory diagram showing a cooling structure example 8 in the projection video display apparatus according to the embodiment of the present invention;

FIG. 19 is a flow diagram showing an operation example 1 of an ambient air sensor of the projection video display apparatus according to the embodiment of the present invention;

FIG. 20 is a flow diagram showing an operation example 2 of an ambient air sensor of the projection video display apparatus according to the embodiment of the present invention;

FIG. 21 is a flow diagram showing an operation example of a protection sensor of the projection video display apparatus according to the embodiment of the present invention;

FIG. 22 is an explanatory diagram showing a setting example of a cooling fan variable speed following an ambient air temperature using the ambient air sensor in the projection video display apparatus according to the embodiment of the present invention;

FIG. 23 is an explanatory diagram showing an example of component temperature change by the ambient air temperature corresponding to FIG. 22;

FIG. 24 is an explanatory diagram showing a control example of an opening using the ambient air sensor and the protection sensor in the projection video display apparatus according to the embodiment of the present invention;

FIG. 25 is an explanatory diagram showing a control example 1 of the opening using the ambient air sensor in the projection video display apparatus according to the embodiment of the present invention;

FIG. 26 is an explanatory diagram showing a control example 2 of the opening using the ambient air sensor in the projection video display apparatus according to the embodiment of the present invention;

FIG. 27 is an explanatory diagram showing a control example of the opening using the protection sensor in the projection video display apparatus according to the embodiment of the present invention;

FIG. 28 is an explanatory diagram showing a shape example 1 of a control plate of the opening in the projection video display apparatus according to the embodiment of the present invention; and

FIG. 29 is an explanatory diagram showing a shape example 2 of the control plate of the opening in the projection video display apparatus according to the embodiment of the present invention.

### DETAILED DESCRIPTION OF PREFERRED EMBODIMENTS

Hereinafter, an embodiment of the present invention will be described in detail with reference to the drawings. Note that the same parts are denoted by the same reference characters throughout the drawings for describing the embodiment, and the repetitive description thereof will be omitted. Meanwhile, a part that has been attached with a reference character and described with reference to a certain drawing is sometimes referred to with the same reference character in the description of other drawings though not illustrated again.

### Embodiment

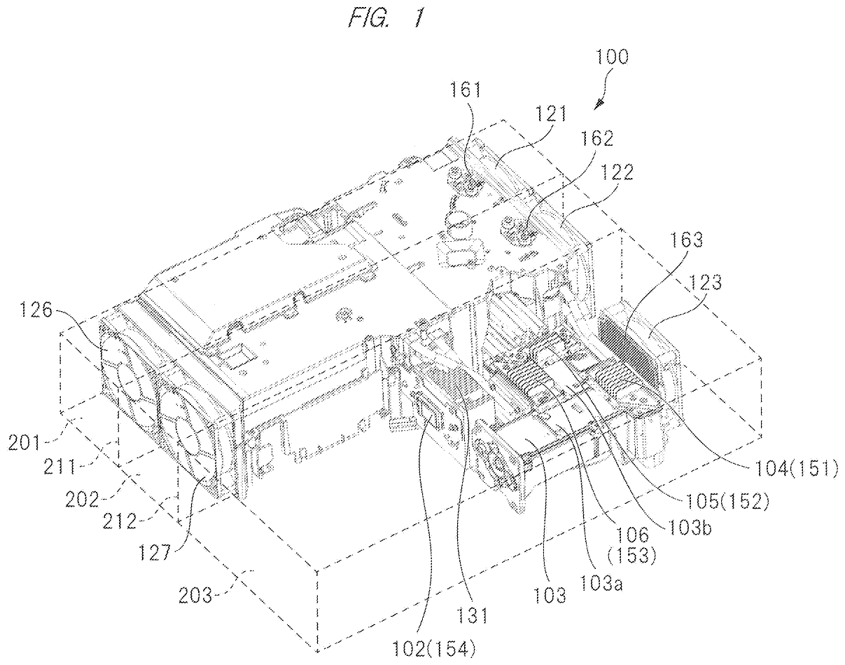

A projection video display apparatus according to an embodiment will be described with reference to FIG. 1 to FIG. 29.

### Configuration Example of Projection Video Display Apparatus

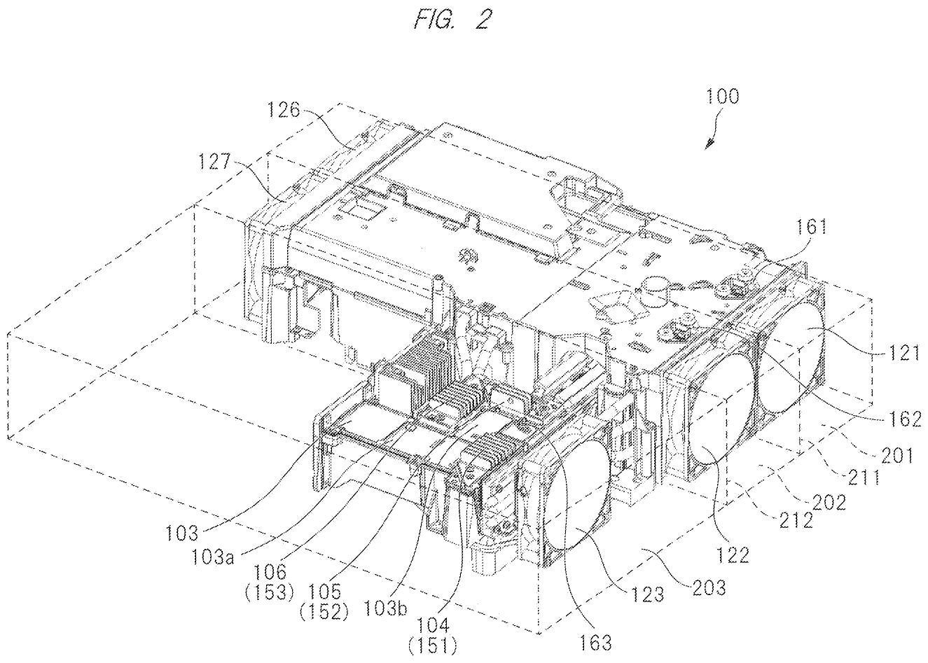

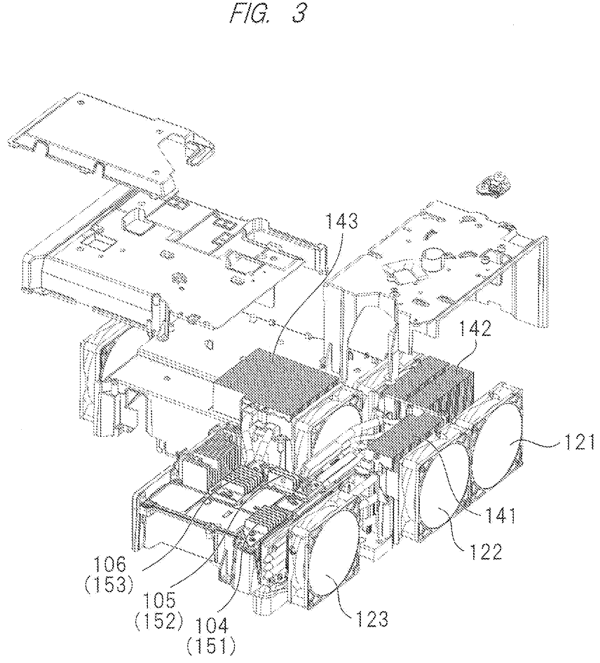

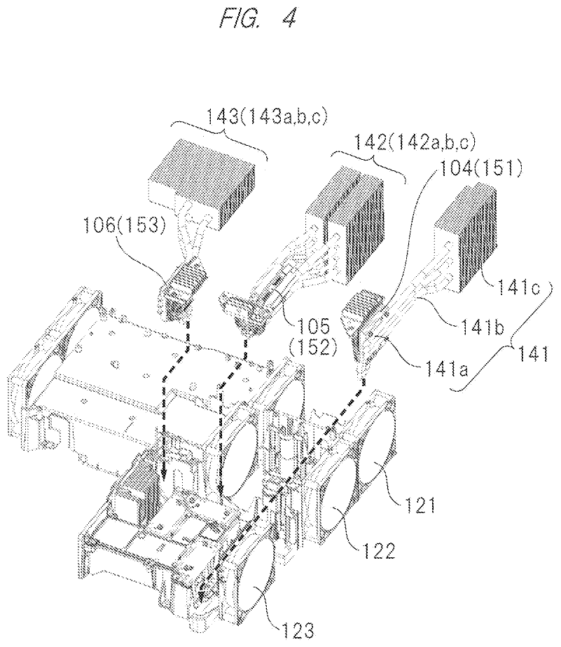

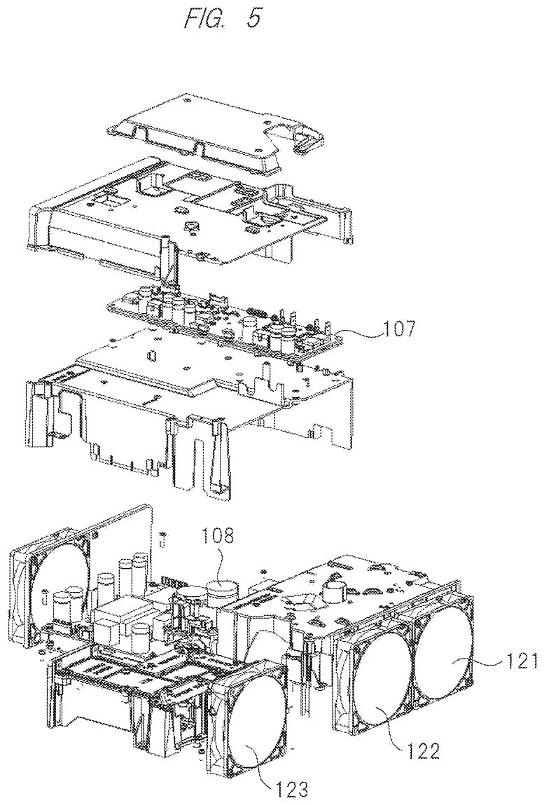

A configuration example of a projection video display apparatus according to the present embodiment will be described with reference to FIG. 1 to FIG. 9. FIG. 1 is a perspective view on a front side showing an example of an internal layout of the projection video display apparatus according to the present embodiment. FIG. 2 is a perspective view on a back side showing the example of the internal layout of the projection video display apparatus according to the present embodiment. FIG. 3 is an exploded perspective view on the back side showing FIG. 2 in an exploded manner. FIG. 4 is an exploded perspective view on the back side showing FIG. 3 in an exploded manner. FIG. 5 is an exploded perspective view on the back side showing FIG. 2 in an exploded manner.

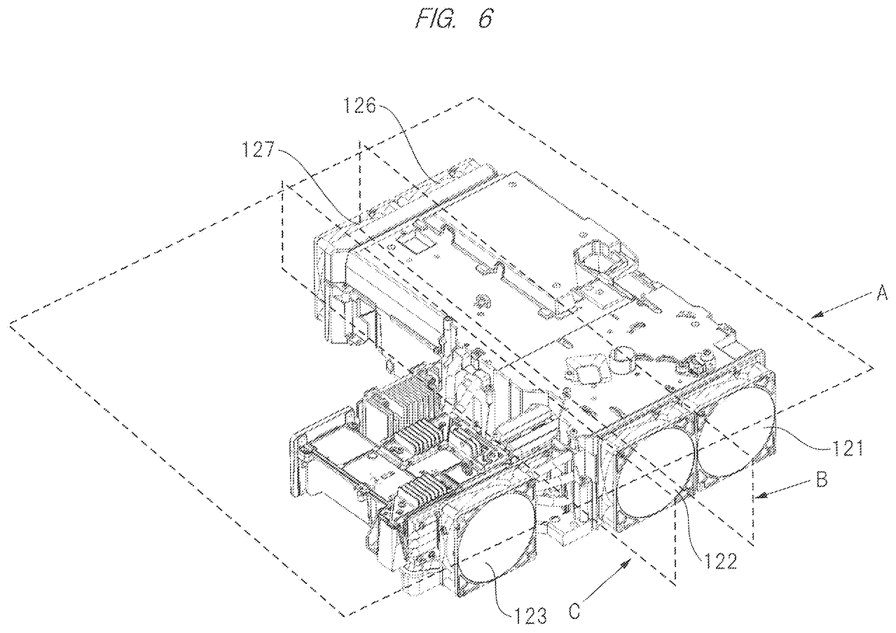

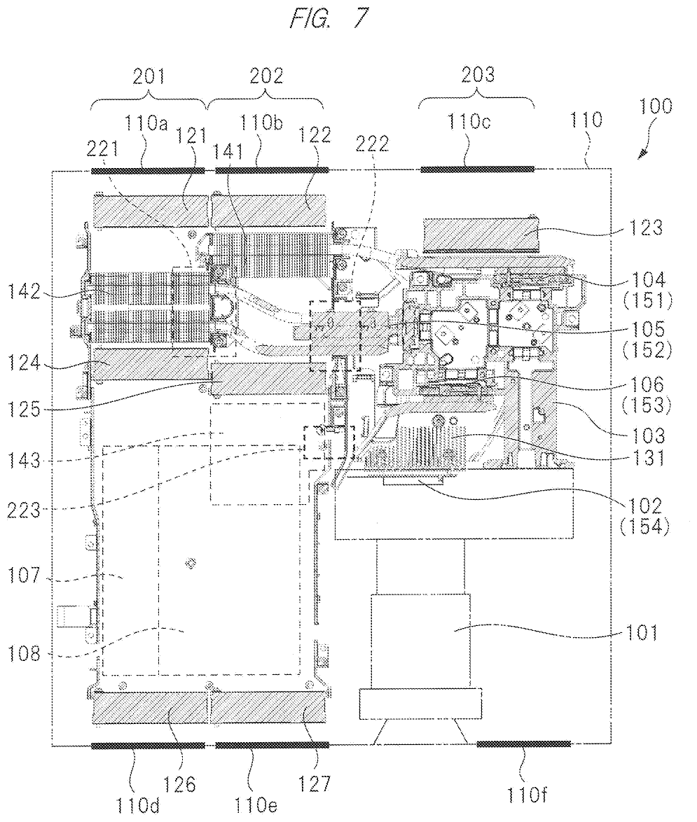

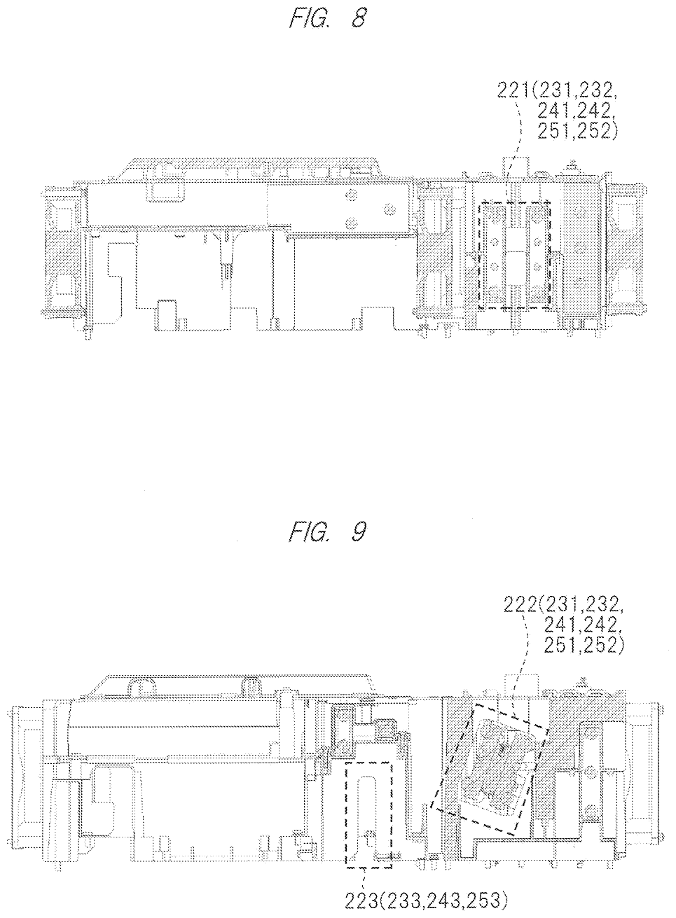

FIG. 6 is a perspective view on the back side showing the example of the internal layout for describing each cross section in the perspective view of FIG. 2. FIG. 7 is a cross-sectional view showing a cross section A of FIG. 6. FIG. 8 is a cross-sectional view showing a cross section B of FIG. 6. FIG. 9 is a cross-sectional view showing a cross section C of FIG. 6.

Note that a projection optical system is omitted in FIG. 1 to FIG. 9 in order to make the internal layout of the projection video display apparatus easily understood. However, a projection optical system 101 is indicated by a two-dot chain line in FIG. 7. Further, a housing 110 is also indicated by a two-dot chain line in FIG. 7.

A projection video display apparatus 100 according to the present embodiment is a projector including the projection optical system 101, a display device 102, an illumination optical system 103, light sources 104 to 106, a controller 107, a power supply unit 108, cooling fans 121 to 127, a cooling module 131, heat pipes 141 to 143, protection sensors 151 to 154, ambient air sensors 161 to 163, ducts 201 to 203 and others, and these are provided in the housing 110 (having, for example, a substantially cuboid shape) indicated by a two-dot chain line in FIG. 7.

In FIG. 7, the projection optical system 101 is an optical system configured to project a video onto a screen (not shown), and includes, for example, a projection lens (or an optical element such as a mirror). The projection optical system 101 is disposed so that one end from which the video is projected is exposed by the projection lens from a front surface of the housing 11. Also, in the front surface of the housing 110, air outlets 110d and 110e of cooling air are provided on the left side of the one end of the projection lens and an air outlet 110f of cooling air is provided on the right side of the one end of the projection lens. Further, in a back surface opposite to the front surface of the housing 110, an air inlet 110a corresponding to the air outlet 110d, an air inlet 110b corresponding to the air outlet 110e, and an air inlet 110c corresponding to the air outlet 110f are provided as the air inlets of the cooling air.

In FIG. 7, the display device 102 is provided on the other end side of the projection lens in the projection optical system 101. This display device 102 is a device configured to generate the video to be projected, and a DMD (Digital Micromirror Device) (registered trademark) panel or the like is used.

The cooling module 131 is attached to the display device 102. This cooling module 131 has a radiator fin made of, for example, aluminum and diffuses and radiates the heat generated when the display device 102 is driven. The protection sensor 154 configured to detect the temperature of the display device 102 is disposed near the display device 102.

The display device 102 generates the video to be projected based on the driving signal in accordance with the video signal output from the controller 107 of the projection video display apparatus 100. Note that the display device 102 is not limited to the DMD panel and may be, for example, a transmissive liquid crystal panel or a reflective liquid crystal panel.

In FIG. 7 and others, the L-shaped illumination optical system 103 is disposed on the right side of the display device 102. The illumination optical system 103 is composed of a parallel portion 103a extending in parallel to the projection optical system 101 and a right-angle portion 103b extending in a right-angle direction from a tip of the parallel portion 103a.

The illumination optical system 103 is an optical system configured to collect the illumination light generated by the light source unit including the light sources 104 to 106 and emit more uniform light to the display device 102. The light sources 104 to 106 are configured to generate the illumination light for projection, and are made up of three light sources such as a red light source 104, a green light source 105, and a blue light source 106. The light emission of the light source unit including the three light sources 104 to 106 is controlled by the controller 107 of the projection video display apparatus 100.

The red light source 104 is, for example, an LED configured to emit red color light. The green light source 105 is, for example, an LED configured to emit green color light. The blue light source 106 is, for example, an LED configured to emit blue color light.

The red light source 104 and the blue light source 106 are each composed of, for example, a planar light emitting device. The protection sensor 151 configured to detect the temperature of the red light source 104 is disposed near the red light source 104. The protection sensor 153 configured to detect the temperature of the blue light source 106 is disposed near the blue light source 106.

The green light source 105 is, for example, an LED including a rod lens. The HLD (High Lumen Density) technology is used for the green light source 105. The protection sensor 152 configured to detect the temperature of the green light source 105 is incorporated in the green light source 105. The rod lens is a cylindrical lens having a quadratic refractive index distribution in the radial direction, such rod lenses are arranged in an array, and the light generated from the green light source 105 is emitted from the light emitting surface configured of the rod lens.

The red light source 104 is disposed on one side surface of the right-angle portion 103b of the illumination optical system 103, and the blue light source 106 is disposed on the other side surface opposite to the one side surface of the right-angle portion 103b. The green light source 105 is disposed at the tip portion of the right-angle portion 103b of the illumination optical system 103.

In addition, the projection video display apparatus 100 includes the power supply unit 108. The power supply unit 108 receives a power supply from an external power source and supplies an operating power to each unit such as the controller 107 configured to control the light sources 104 to 106 and the display device 102 described above.

The heat pipe 141 configured to cool the red light source 104 includes, for example, a heat receiving portion 141a, a pipe portion 141b, and a fin portion 141c. In the heat pipe 141, the heat receiving portion 141a is provided at one end thereof, the fin portion 141c is provided at the other end thereof, and the pipe portion 141b is present between the heat receiving portion 141a and the fin portion 141c. The heat receiving portion 141a is attached to the LED of the red light source 104.

The heat pipe 141 is configured to contain a working liquid such as water in a metal pipe made of, for example, copper. Although the configuration including three heat pipes 141 is described here, the number of heat pipes may be changed in accordance with the amount of heat generated by the LED.

The fin portion 141c is, for example, a metal plate made of aluminum or copper. A circular hole having almost the same size as the heat pipe 141 is formed in the plane of the metal plate. Then, the pipe portion 141b of the heat pipe 141 is inserted in the circular hole formed in the metal plate. The fin portion 141c is disposed in the duct 202 to be the cooling air path. Note that the fin portion 141c is not always necessary if the sufficient cooling is achieved by only the heat pipe 141.

Here, the operation principle of the heat pipe 141 will be described. The same is true of the operation principles of the other heat pipes 142 and 143 described later.

First, when the working liquid boils by the heat generated by the LED of the red light source 104, the vapor generated by the boiling flows from the heat receiving portion 141a (high temperature side) to the fin portion 141c (low temperature side) due to the pressure difference. As the vapor condenses, heat of condensation is released from the fin portion 141c. Thereafter, the condensed working liquid returns to the heat receiving portion 141c by the capillary action. As described above, the heat pipe 141 transports the heat by the phase change between the evaporation and the condensation of the contained working liquid.

As with the heat pipe 141 configured to cool the red light source 104, the heat pipe 142 configured to cool the green light source 105 also includes, for example, a heat receiving portion 142a, a pipe portion 142b, and a fin portion 142c. The heat receiving portion 142a is attached to the LED of the green light source 105. The fin portion 142c is disposed in the duct 201 to be the cooling air path.

Similarly, the heat pipe 143 configured to cool the blue light source 106 also includes, for example, a heat receiving portion 143a, a pipe portion 143b, and a fin portion 143c. The heat receiving portion 143a is attached to the LED of the blue light source 106. The fin portion 143c is disposed in the duct 202 to be the cooling air path.

The ducts 201 to 203 are spaces to be the cooling air paths in the housing 110. The ducts 201 to 203 take ambient air serving as cooling air into the housing 110 from the air inlets 110a to 110c provided on the back surface of the housing 110, and exhaust the air from the air outlets 110d to 110f provided on the front surface of the housing 110. The cooling fans 121 to 127 are fans that take the ambient air into the housing 110 from the outside and release the heat generated by the optical system components and electronic components to be cooled to the outside, thereby suppressing the temperature rise.

The duct 201 is configured to cool the green light source 105, the controller 107, and the power supply unit 108. The duct 201 stores the cooling fans 121, 124, and 126 that cool the heat from the green light source 105, the controller 107, and the power supply unit 108. In the duct 201, the cooling fan 121, the heat pipe 142 of the green light source 105, the cooling fan 124, the controller 107, the power supply unit 108, and the cooling fan 126 are disposed in order from the upstream side to the downstream side in the cooling air path from the air inlet 110a to the air outlet 110d. The ambient air sensor 161 configured to detect the temperature of ambient air taken from the air inlet 110a is disposed at the air inlet 110a of the duct 201.

The duct 202 is configured to cool the red light source 104, the blue light source 106, and the power supply unit 108. The duct 202 stores the cooling fans 122, 125, and 127 that cool the heat from the red light source 104, the blue light source 106, and the power supply unit 108. In the duct 202, the cooling fan 122, the heat pipe 141 of the red light source 104, the cooling fan 125, the heat pipe 143 of the blue light source 106, the power supply unit 108, and the cooling fan 127 are disposed in order from the upstream side to the downstream side in the cooling air path from the air inlet 110b to the air outlet 110e. The ambient air sensor 162 configured to detect the temperature of ambient air taken from the air inlet 110b is disposed at the air inlet 110b of the duct 202.

The duct 203 is configured to cool the display device 102. The duct 203 stores the cooling fans 123 that cools the heat from the display device 102. In the duct 203, the cooling fan 123 and the cooling module 131 of the display device 102 are disposed in order from the upstream side to the downstream side in the cooling air path from the air inlet 110c to the air outlet 110f. The ambient air sensor 163 configured to detect the temperature of ambient air taken from the air inlet 110c is disposed at the air inlet 110c of the duct 203.

### Example of Basic Structure for Cooling in Projection Video Display Apparatus

For example, the projection video display apparatus according to the present embodiment is sometimes installed at a place where an air inlet through which air for cooling the LED used as a light source is taken is blocked. Since the air inlet is blocked in such a case, the cooling air does not flow in the duct and the temperature of the LED rises during the operation of the apparatus, so that the lifetime of the LED is decreased when the temperature reaches a prescribed temperature or higher. Therefore, it is necessary to control the temperature of the LED to an appropriate temperature or lower even when the air inlet is blocked.

In particular, in the structure including the LED for the red light source, the LED for the green light source, and the LED for the blue light source and a plurality of ducts to be the cooling air paths corresponding to each LED, the decrease in lifetime becomes remarkable. For example, when the air inlet of the duct corresponding to a certain LED among the plurality of LEDs is blocked, it is not possible to cool the LED and the lifetime of the LED is decreased more rapidly than the other LEDs, resulting in the significant decrease in the lifetime of the overall apparatus.

Further, in the projection video display apparatus, the display device, the controller, the power supply unit and others also generate heat other than the light source of the LED, and it is desirable to control these components to an appropriate temperature or lower. Namely, the projection video display apparatus includes various heat generating members including the light source, the display device, the controller, and the power supply unit as optical system components and electronic components, and it is desirable to control these heat generating members to an appropriate temperature or lower.

Thus, the present embodiment provides a projection video display apparatus capable of, even when an air inlet of a certain duct among a plurality of ducts is blocked in the configuration including the optical system components and the electronic components, securing a cooling air path to the duct whose air inlet is blocked.

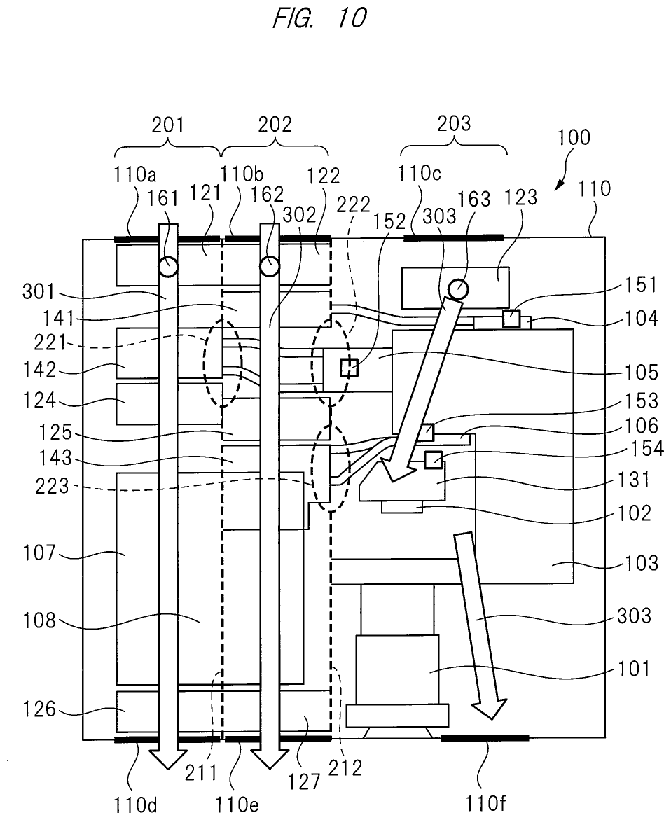

FIG. 10 is an explanatory diagram showing an example of a basic structure for cooling in the projection video display apparatus 100 according to the present embodiment. FIG. 10 shows a schematic internal layout of the projection video display apparatus 100 seen from the upper surface side.

As shown in FIG. 10, the projection video display apparatus 100 according to the present embodiment includes, as a plurality of heat generating members that generate heat including optical system components or electronic components to be cooled, the green light source 105, the controller 107, and the power supply unit 108 serving as the first heat generating member, the red light source 104, the blue light source 106, and the power supply unit 108 serving as the second heat generating member, and the display device 102 serving as the third heat generating member.

As shown in FIG. 10, the projection video display apparatus 100 according to the present embodiment includes, as the plurality of ducts serving as cooling air paths, the first duct 201, the second duct 202 adjacent to the first duct 201, and the third duct 203 adjacent to the second duct 202.

The first duct 201 is configured to cool the heat from the first heat generating member among the plurality of heat generating members. The first duct 201 stores the first, second, and third cooling fans 121, 126, and 124 configured to cool the heat from the green light source 105, the controller 107, and the power supply unit 108 serving as the first heat generating member. The first cooling fan 121 is disposed at the side of the air inlet 110a of the first duct 201, the second cooling fan 126 is disposed at the side of the air outlet 110d of the first duct 201, and the third cooling fan 124 is disposed between the air inlet 110a and the air outlet 110d of the first duct 201.

In the first duct 201, the heat pipe 142 (fin portion 142c) of the green light source 105 is disposed between the first cooling fan 121 and the third cooling fan 124. In the first duct 201, the controller 107 and the power supply unit 108 are disposed between the third cooling fan 124 and the second cooling fan 126. In the first duct 201, cooling air 301 is taken from the air inlet 110a and is exhausted from the air outlet 110d.

In the first duct 201, the first cooling fan 121, the heat pipe 142 of the green light source 105, the third cooling fan 124, the controller 107, the power supply unit 108, and the second cooling fan 126 are disposed in order from the upstream side to the downstream side in the path of the cooling air 301 from the air inlet 110a to the air outlet 110d.

The second duct 202 is configured to cool the heat from the second heat generating member among the plurality of heat generating members. The second duct 202 stores the fourth, fifth, and sixth cooling fans 122, 127, and 125 configured to cool the heat from the red light source 104, the blue light source 106, and the power supply unit 108 serving as the second heat generating member. The fourth cooling fan 122 is disposed at the side of the air inlet 110b of the second duct 202, the fifth cooling fan 127 is disposed at the side of the air outlet 110e of the second duct 202, and the sixth cooling fan 125 is disposed between the air inlet 110b and the air outlet 110e of the second duct 202.

In the second duct 202, the heat pipe 141 (fin portion 141c) of the red light source 104 is disposed between the fourth cooling fan 122 and the sixth cooling fan 125. In the second duct 202, the heat pipe 143 (fin portion 143c) of the blue light source 106 and the power supply unit 108 are disposed between the sixth cooling fan 125 and the fifth cooling fan 127. In the second duct 202, cooling air 302 is taken from the air inlet 110b and is exhausted from the air outlet 110e.

In the second duct 202, the fourth cooling fan 122, the heat pipe 141 of the red light source 104, the sixth cooling fan 125, the heat pipe 143 of the blue light source 106, the power supply unit 108, and the fifth cooling fan 127 are disposed in order from the upstream side to the downstream side in the path of the cooling air 302 from the air inlet 110b to the air outlet 110e.

The third duct 203 is configured to cool the heat from the third heat generating member among the plurality of heat generating members. The third duct 203 stores the seventh cooling fan 123 configured to cool the heat from the display device 102 serving as the third heat generating member. The seventh cooling fan 123 is disposed at the side of the air inlet 110c of the third duct 203.

In the third duct 203, the cooling module 131 of the display device 102 is disposed on the downstream side of the seventh cooling fan 123. In the third duct 203, cooling air 303 is taken from the air inlet 110c and is exhausted from the air outlet 110f.

In the third duct 203, the seventh cooling fan 123 and the cooling module 131 of the display device 102 are disposed in order from the upstream side to the downstream side in the path of the cooling air 303 from the air inlet 110c to the air outlet 110f.

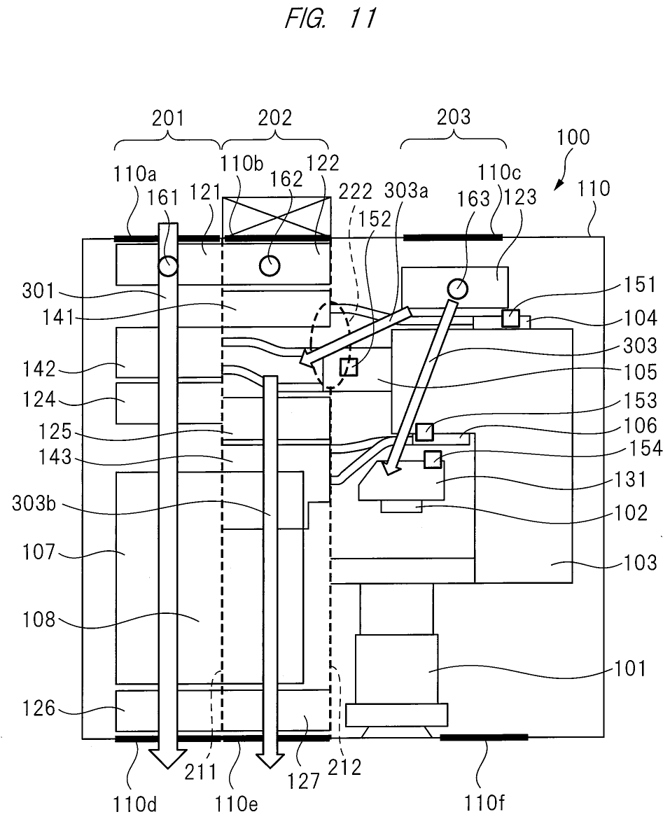

The projection video display apparatus 100 according to the present embodiment is configured to have openings in order to secure a cooling air path to the duct whose air inlet is blocked even when the air inlet of a certain duct among the air inlet 110a of the first duct 201, the air inlet 110b of the second duct 202, and the air inlet 110c of the third duct 203 is blocked. Although the detail thereof will be described later (FIG. 11 to FIG. 18: cooling structure examples 1 to 8), openings 221, 222, and 223 are provided in a wall surface 211 between the first duct 201 and the second duct 202, a wall surface 212 between the second duct 202 and the third duct 203, or both of the wall surfaces 211 and 212.

In the projection video display apparatus 100 according to the present embodiment, the openings 221, 222, and 223 are disposed near the heat generating members. The term “near” means, for example, the position in the range where the cooling air directed from the openings 221, 222, and 223 reaches the heat generating members.

For example, the opening 221 is disposed near the heat pipe 141 of the red light source 104 and the heat pipe 142 of the green light source 105. The opening 222 is disposed near the heat pipe 141 of the red light source 104 and the heat pipe 142 of the green light source 105. The opening 223 is disposed near the heat pipe 143 of the blue light source 106 and the cooling module 131 of the display device 102.

In the projection video display apparatus 100 according to the present embodiment, the cooling air flowing out from the openings 221, 222, and 223 is directed toward the heat generating members.

For example, the cooling air flowing out from the opening 221 is directed toward the heat pipe 142 of the green light source 105, the controller 107, and the power supply unit 108 in the first duct 201. The cooling air flowing out from the opening 221 is directed toward the heat pipe 143 of the blue light source 106 and the power supply unit 108 in the second duct 202.

The cooling air flowing out from the opening 222 is directed toward the heat pipe 143 of the blue light source 106 and the power supply unit 108 in the second duct 202. The cooling air flowing out from the opening 222 is directed toward the cooling module 131 of the display device 102 in the third duct 203.

The cooling air flowing out from the opening 223 is directed toward the heat pipe 143 of the blue light source 106 and the power supply unit 108 in the second duct 202. The cooling air flowing out from the opening 223 is directed toward the cooling module 131 of the display device 102 in the third duct 203.

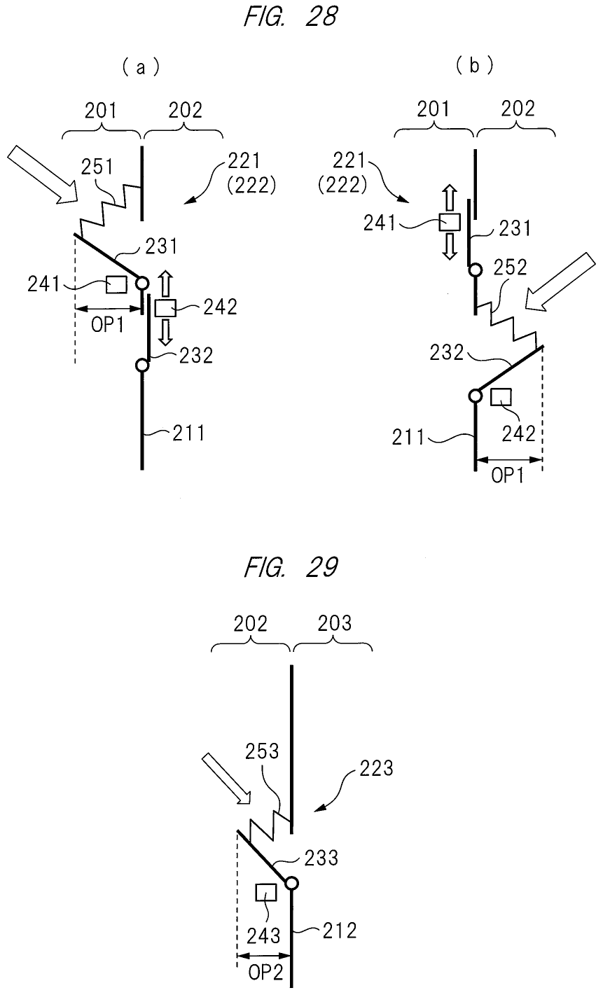

In the projection video display apparatus 100 according to the present embodiment, the openings 221, 222, and 223 have control plates 231, 232, and 233 (FIG. 28, FIG. 29) configured to direct the cooling air to the arbitrary duct (for example, the duct in which the heat generating member whose temperature rises is disposed) and control the air volume thereof based on the result of the detection of the temperature of the heat generating member.

For example, the control plates 231, 232, and 233 of the openings 221, 222, and 223 can open and close the openings 221, 222, and 223, and the cooling air is directed from the openings 221, 222, and 223 in the open state and the cooling air is not directed from the openings 221, 222, and 223 in the closed state. Further, the air volume of the cooling air to be directed from the openings 221, 222, and 223 is controlled by the opening degree of the openings 231, 232, and 233.

In the projection video display apparatus 100 according to the present embodiment, at least one component whose temperature needs to be managed among the heat generating members is disposed on the downstream side of the openings 221, 222, and 223.

For example, as the component whose temperature needs to be controlled, the heat pipe 142 of the green light source 105, the controller 107, and the power supply unit 108 are disposed on the downstream side of the opening 221 in the first duct 201. The heat pipe 143 of the blue light source 106 and the power supply unit 108 are disposed on the downstream side of the opening 221 in the second duct 202.

The heat pipe 143 of the blue light source 106 and the power supply unit 108 are disposed on the downstream side of the opening 222 in the second duct 202. The cooling module 131 of the display device 102 is disposed on the downstream side of the opening 222 in the third duct 203.

The heat pipe 143 of the blue light source 106 and the power supply unit 108 are disposed on the downstream side of the opening 223 in the second duct 202. The cooling module 131 of the display device 102 is disposed on the downstream side of the opening 223 in the third duct 203.

Hereinafter, the cooling structure examples 1 to 8 based on the example of the basic structure for cooling in the projection video display apparatus 100 according to the present embodiment will be described in detail.

### Cooling Structure Example 1

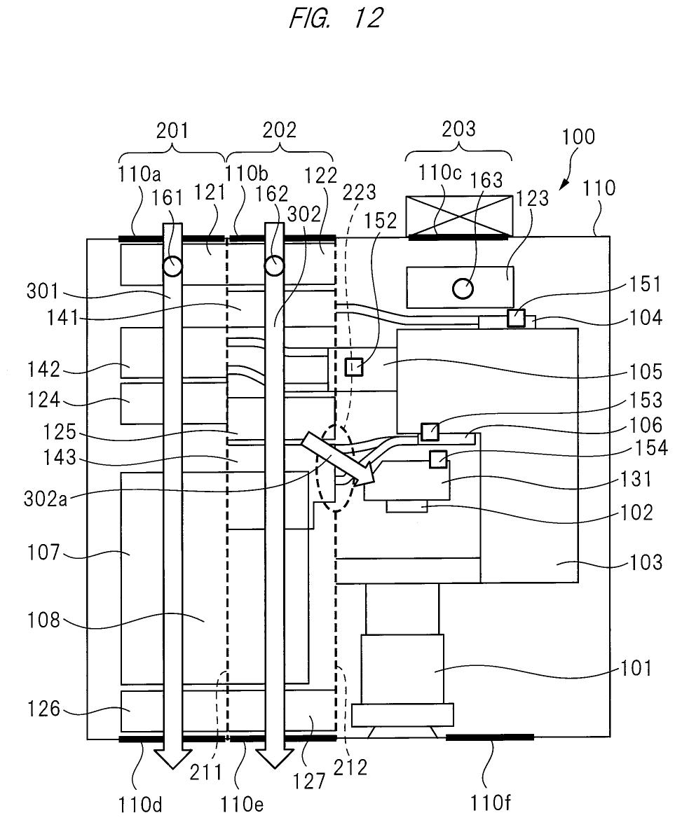

FIG. 11 is an explanatory diagram showing the cooling structure example 1 in the projection video display apparatus 100 according to the present embodiment. As with FIG. 10, FIG. 11 shows a schematic internal layout of the projection video display apparatus 100 seen from the upper surface side. The same is true of FIG. 12 to FIG. 18 to be described later.

As shown in FIG. 11, the cooling structure example 1 corresponds to the case where the air inlet 110b of the second duct 202 is blocked (the portion where the air inlet is blocked is indicated by x mark in a rectangle, and the same is true of FIG. 12 to FIG. 18 to be described later). The cooling structure example 1 has the first opening 222 in the wall surface 212 between the second duct 202 and the third duct 203.

When the air inlet 110b of the second duct 202 is blocked, cooling air 303a flowing out from the first opening 222 is directed toward the second duct 202 from the third duct 203. Namely, the cooling air 303a flowing out from the first opening 222 is branched from the cooling air 303 flowing in the third duct 203 and is directed to the second duct 202 as cooling air 303b.

Thus, even when the air inlet 110b of the second duct 202 is blocked, the cooling air path to the second duct 202 in which the air inlet 110b is blocked is secured, so that the red light source 104, the blue light source 106, and the power supply unit 108 serving as the second heat generating member can be cooled by the cooling airs 303a and 303b directed from the third duct 203 to the second duct 202.

Note that, since the cooling air path to the first duct 201 and the third duct 203 can be secured in the cooling structure example 1, it is possible to cool the green light source 105, the controller 107, and the power supply unit 108 serving as the first heat generating member and the display device 102 serving as the third heat generating member.

### Cooling Structure Example 2

FIG. 12 is an explanatory diagram showing the cooling structure example 2 in the projection video display apparatus 100 according to the present embodiment.

As shown in FIG. 12, the cooling structure example 2 corresponds to the case where the air inlet 110c of the third duct 203 is blocked. The cooling structure example 2 has the second opening 223 in the wall surface 212 between the second duct 202 and the third duct 203.

When the air inlet 110c of the third duct 203 is blocked, cooling air 302a flowing out from the second opening 223 is directed toward the third duct 203 from the second duct 202. Namely, the cooling air 302a flowing out from the second opening 223 is branched from the cooling air 302 flowing in the second duct 202 and is directed to the third duct 203.

Thus, even when the air inlet 110c of the third duct 203 is blocked, the cooling air path to the third duct 203 in which the air inlet 110c is blocked is secured, so that the display device 102 serving as the third heat generating member can be cooled by the cooling air 302a directed from the second duct 202 to the third duct 203.

Note that, since the cooling air path to the first duct 201 and the second duct 202 can be secured in the cooling structure example 2, it is possible to cool the green light source 105, the controller 107, and the power supply unit 108 serving as the first heat generating member and the red light source 104, the blue light source 106, and the power supply unit 108 serving as the second heat generating member.

### Cooling Structure Example 3

FIG. 13 is an explanatory diagram showing the cooling structure example 3 in the projection video display apparatus 100 according to the present embodiment.

As shown in FIG. 13, the cooling structure example 3 corresponds to the case where the air inlet 110b of the second duct 202 is blocked. The cooling structure example 3 has the third opening 221 in the wall surface 211 between the first duct 201 and the second duct 202.

When the air inlet 110b of the second duct 202 is blocked, cooling air 301a flowing out from the third opening 221 is directed toward the second duct 202 from the first duct 201. Namely, the cooling air 301a flowing out from the third opening 221 is branched from the cooling air 301 flowing in the first duct 201 and is directed to the second duct 202 as cooling air 301b.

Thus, even when the air inlet 110b of the second duct 202 is blocked, the cooling air path to the second duct 202 in which the air inlet 110b is blocked is secured, so that the red light source 104, the blue light source 106, and the power supply unit 108 serving as the second heat generating member can be cooled by the cooling airs 301a and 301b directed from the first duct 201 to the second duct 202.

Note that, since the cooling air path to the first duct 201 and the third duct 203 can be secured in the cooling structure example 3, it is possible to cool the green light source 105, the controller 107, and the power supply unit 108 serving as the first heat generating member and the display device 102 serving as the third heat generating member.

### Cooling Structure Example 4

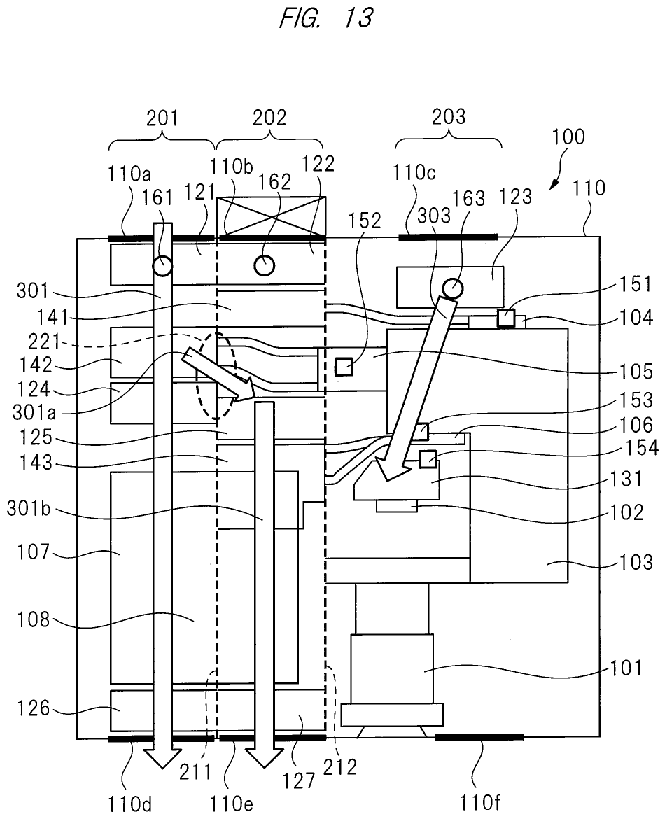

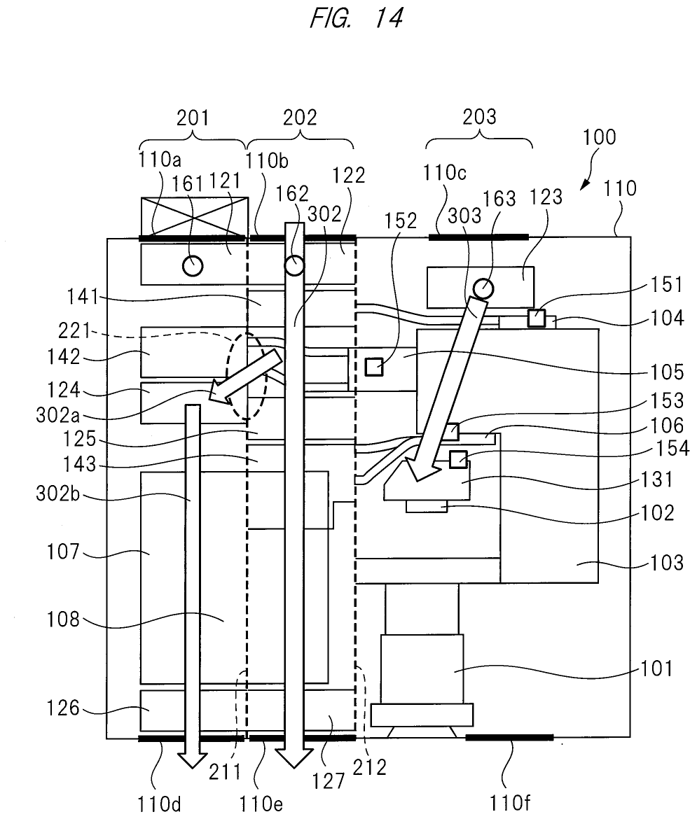

FIG. 14 is an explanatory diagram showing the cooling structure example 4 in the projection video display apparatus 100 according to the present embodiment.

As shown in FIG. 14, the cooling structure example 4 corresponds to the case where the air inlet 110a of the first duct 201 is blocked. The cooling structure example 4 has the third opening 221 in the wall surface 211 between the first duct 201 and the second duct 202.

When the air inlet 110a of the first duct 201 is blocked, cooling air 302a flowing out from the third opening 221 is directed toward the first duct 201 from the second duct 202. Namely, the cooling air 302a flowing out from the third opening 221 is branched from the cooling air 302 flowing in the second duct 202 and is directed to the first duct 201 as cooling air 302b.

Thus, even when the air inlet 110a of the first duct 201 is blocked, the cooling air path to the first duct 201 in which the air inlet 110a is blocked is secured, so that the green light source 105, the controller 107, and the power supply unit 108 serving as the first heat generating member can be cooled by the cooling airs 302a and 302b directed from the second duct 202 to the first duct 201.

Note that, since the cooling air path to the second duct 202 and the third duct 203 can be secured in the cooling structure example 4, it is possible to cool the red light source 104, the blue light source 106, and the power supply unit 108 serving as the second heat generating member and the display device 102 serving as the third heat generating member.

### Cooling Structure Example 5

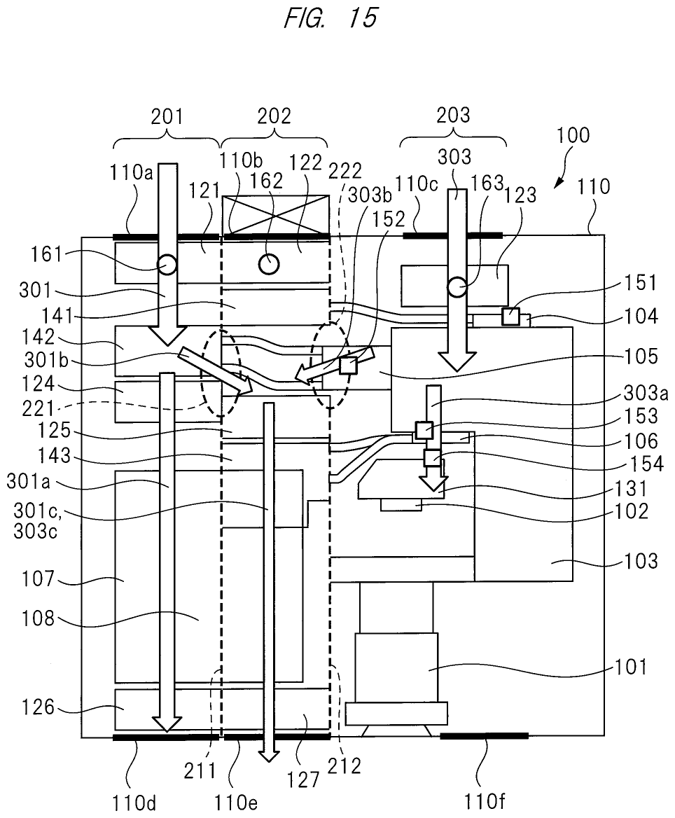

FIG. 15 is an explanatory diagram showing the cooling structure example 5 in the projection video display apparatus 100 according to the present embodiment.

As shown in FIG. 15, the cooling structure example 5 corresponds to the case where the air inlet 110b of the second duct 202 is blocked. The cooling structure example 5 has the third opening 221 in the wall surface 211 between the first duct 201 and the second duct 202. Further, the cooling structure example 5 has the first opening 222 in the wall surface 212 between the second duct 202 and the third duct 203.

When the air inlet 110b of the second duct 202 is blocked, the cooling airs 301b and 303b flowing out from the third opening 221 and the first opening 222 are directed toward the second duct 202 from the first duct 201 and the third duct 203. Namely, the cooling air 301b flowing out from the third opening 221 is branched from the cooling air 301 flowing in the first duct 201 and is directed to the second duct 202 as cooling air 301c. Also, the cooling air 303b flowing out from the first opening 222 is branched from the cooling air 303 flowing in the third duct 203 and is directed to the second duct 202 as cooling air 303c.

Thus, even when the air inlet 110b of the second duct 202 is blocked, the cooling air path to the second duct 202 in which the air inlet 110b is blocked is secured, so that the red light source 104, the blue light source 106, and the power supply unit 108 serving as the second heat generating member can be cooled by the cooling airs 301b, 301c, 303b, and 303c directed from the first duct 201 and the third duct 203 to the second duct 202.

Note that, since the cooling air path to the first duct 201 and the third duct 203 can be secured in the cooling structure example 5, it is possible to cool the green light source 105, the controller 107, and the power supply unit 108 serving as the first heat generating member and the display device 102 serving as the third heat generating member.

### Cooling Structure Example 6

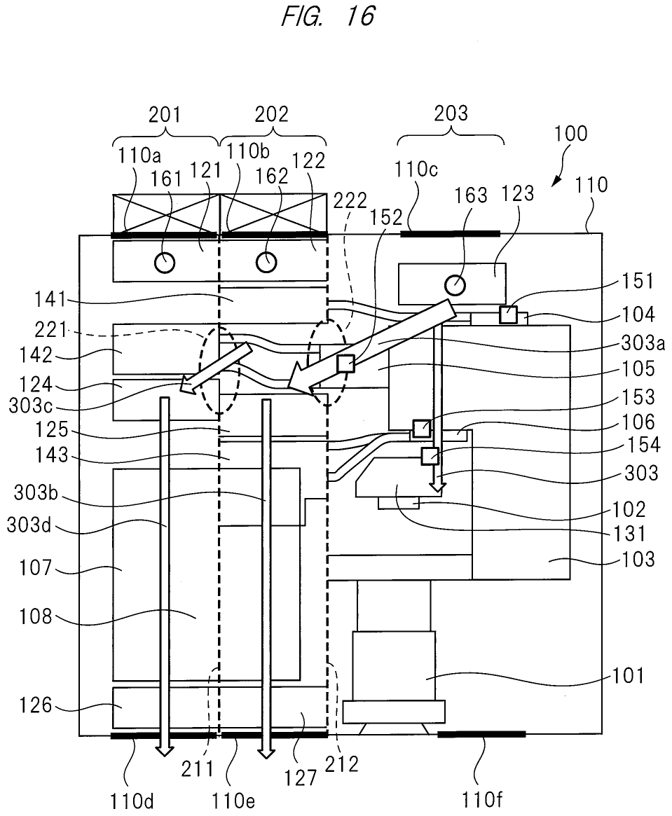

FIG. 16 is an explanatory diagram showing the cooling structure example 6 in the projection video display apparatus 100 according to the present embodiment.

As shown in FIG. 16, the cooling structure example 6 corresponds to the case where the air inlets 110a and 110b of the first duct 201 and the second duct 202 are blocked. The cooling structure example 6 has the third opening 221 in the wall surface 211 between the first duct 201 and the second duct 202. Further, the cooling structure example 6 has the first opening 222 in the wall surface 212 between the second duct 202 and the third duct 203.

When the air inlets 110a and 110b of the first duct 201 and the second duct 202 are blocked, the cooling air 303a flowing out from the first opening 222 is directed toward the second duct 202 from the third duct 203. Further, the cooling air 303c flowing out from the third opening 221 is directed toward the first duct 201 from the second duct 202. Namely, the cooling air 303a flowing out from the first opening 222 is branched from the cooling air 303 flowing in the third duct 203 and is directed to the second duct 202 as the cooling air 303b. Also, the cooling air 303c flowing out from the third opening 221 is branched from the cooling air 303b flowing in the second duct 202 and is directed to the first duct 201 as cooling air 303d.

Thus, even when the air inlets 110a and 110b of the first duct 201 and the second duct 202 are blocked, the cooling air path to the first duct 201 and the second duct 202 in which the air inlets 110a and 110b are blocked is secured, so that the green light source 105, the controller 107, and the power supply unit 108 serving as the first heat generating member and the red light source 104, the blue light source 106, and the power supply unit 108 serving as the second heat generating member can be cooled by the cooling airs 303a, 303b, 303c, and 303d directed from the third duct 203 to the second duct 202 and further directed from the second duct 202 to the first duct 201.

Note that, since the cooling air path to the third duct 203 can be secured in the cooling structure example 6, it is possible to cool the display device 102 serving as the third heat generating member.

### Cooling Structure Example 7

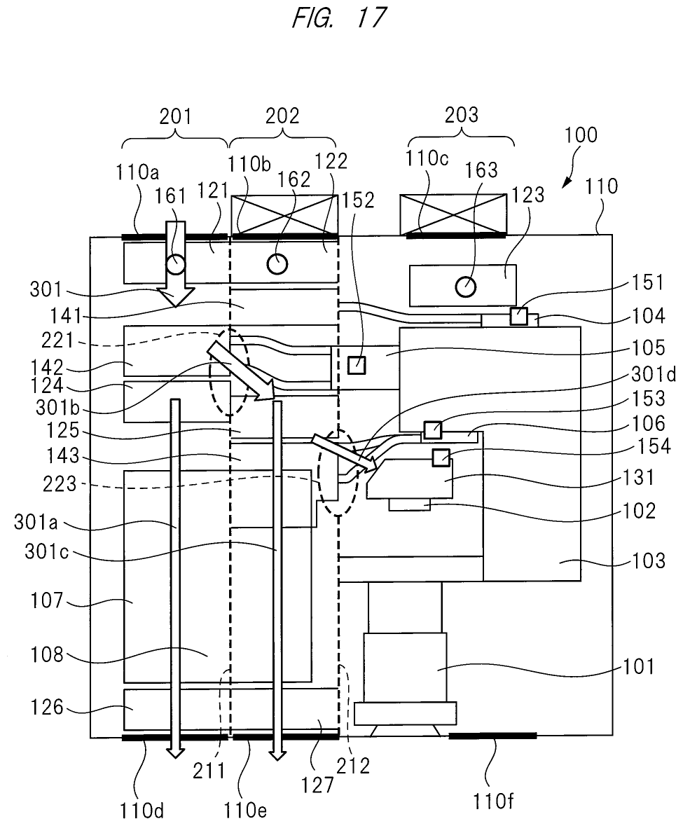

FIG. 17 is an explanatory diagram showing the cooling structure example 7 in the projection video display apparatus 100 according to the present embodiment.

As shown in FIG. 17, the cooling structure example 7 corresponds to the case where the air inlets 110b and 110c of the second duct 202 and the third duct 203 are blocked. The cooling structure example 7 has the third opening 221 in the wall surface 211 between the first duct 201 and the second duct 202. Further, the cooling structure example 7 has the second opening 223 in the wall surface 212 between the second duct 202 and the third duct 203.

When the air inlets 110b and 110c of the second duct 202 and the third duct 203 are blocked, the cooling air 301b flowing out from the third opening 221 is directed toward the second duct 202 from the first duct 201, and the cooling air 301d flowing out from the second opening 223 is directed toward the third duct 203 from the second duct 202. Namely, the cooling air 301b flowing out from the third opening 221 is branched from the cooling air 301 flowing in the first duct 201 and is directed to the second duct 202 as the cooling air 301c. Also, the cooling air 301d flowing out from the second opening 223 is branched from the cooling air 301c flowing in the second duct 202 and is directed to the third duct 203.

Thus, even when the air inlets 110b and 110c of the second duct 202 and the third duct 203 are blocked, the cooling air path to the second duct 202 and the third duct 203 in which the air inlets 110b and 110c are blocked is secured, so that the red light source 104, the blue light source 106, and the power supply unit 108 serving as the second heat generating member and the display device 102 serving as the third heat generating member can be cooled by the cooling airs 301b, 301c, and 301d directed from the first duct 201 to the second duct 202 and further directed from the second duct 202 to the third duct 203.

Note that, since the cooling air path to the first duct 201 can be secured in the cooling structure example 7, it is possible to cool the green light source 105, the controller 107, and the power supply unit 108 serving as the first heat generating member.

### Cooling Structure Example 8

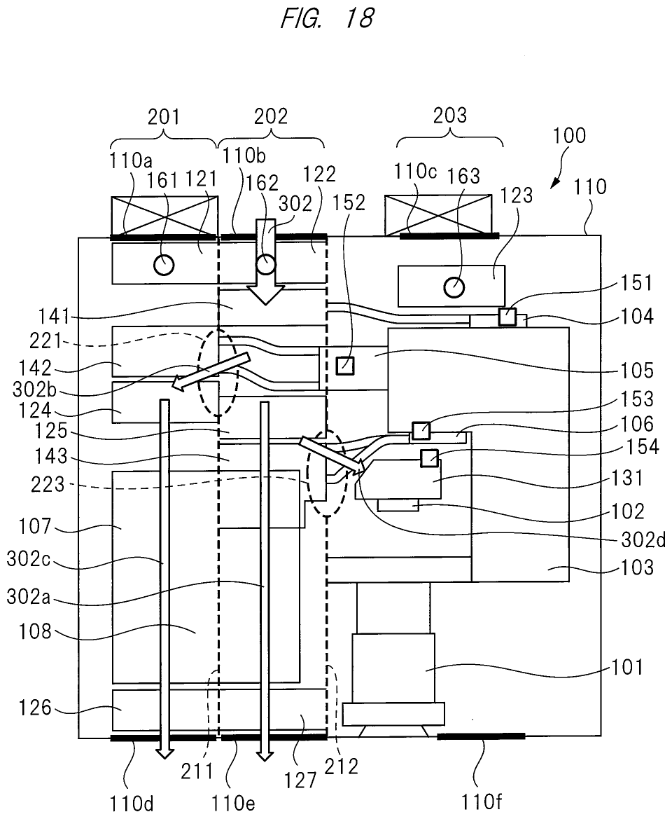

FIG. 18 is an explanatory diagram showing the cooling structure example 8 in the projection video display apparatus 100 according to the present embodiment.

As shown in FIG. 18, the cooling structure example 8 corresponds to the case where the air inlets 110a and 110c of the first duct 201 and the third duct 203 are blocked. The cooling structure example 8 has the third opening 221 in the wall surface 211 between the first duct 201 and the second duct 202. Further, the cooling structure example 8 has the second opening 223 in the wall surface 212 between the second duct 202 and the third duct 203.

When the air inlets 110a and 110c of the first duct 201 and the third duct 203 are blocked, the cooling air 302b flowing out from the third opening 221 is directed toward the first duct 201 from the second duct 202, and the cooling air 302d flowing out from the second opening 223 is directed toward the third duct 203 from the second duct 202. Namely, the cooling air 302b flowing out from the third opening 221 is branched from the cooling air 302 flowing in the second duct 202 and is directed to the first duct 201 as the cooling air 302c. Also, the cooling air 302d flowing out from the second opening 223 is branched from the cooling air 302a flowing in the second duct 202 and is directed to the third duct 203.

Thus, even when the air inlets 110a and 110c of the first duct 201 and the third duct 203 are blocked, the cooling air path to the first duct 201 and the third duct 203 in which the air inlets 110a and 110c are blocked is secured, so that the green light source 105, the controller 107, and the power supply unit 108 serving as the first heat generating member and the display device 102 serving as the third heat generating member can be cooled by the cooling airs 302b, 302c, and 302d directed from the second duct 202 to the first duct 201 and the third duct 203.

Note that, since the cooling air path to the second duct 202 can be secured in the cooling structure example 8, it is possible to cool the red light source 104, the blue light source 106, and the power supply unit 108 serving as the second heat generating member.

### Operation Example 1 of Ambient Air Sensor

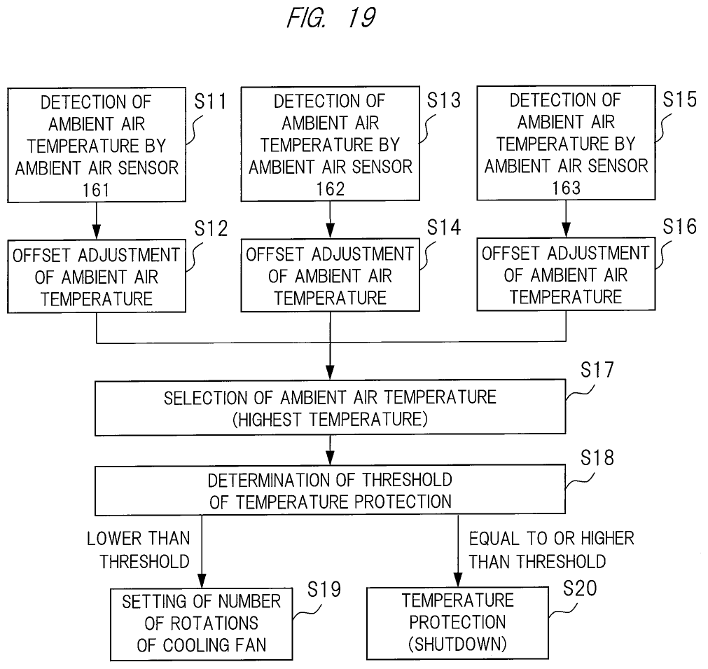

FIG. 19 is a flow diagram showing the operation example 1 of the ambient air sensor of the projection video display apparatus 100 according to the present embodiment.

The ambient air sensor 161 is the second sensor configured to detect the temperature of the cooling air 301 (ambient air) taken into the first duct 201 from outside. The ambient air sensor 162 is the second sensor configured to detect the temperature of the cooling air 302 (ambient air) taken into the second duct 202 from outside. The ambient air sensor 163 is the second sensor configured to detect the temperature of the cooling air 303 (ambient air) taken into the third duct 203 from outside. These ambient air sensors 161, 162, and 163 are disposed at the air inlets 110a, 110b, and 110c of the ducts 201, 202, and 203, respectively.

As shown in FIG. 19, the temperature of the ambient air taken into the first duct 201 from outside is detected by the ambient air sensor 161 (S11). The temperature detected by the ambient air sensor 161 is sent to the controller 107 in the projection video display apparatus 100, and the offset adjustment of the detected temperature is performed in the controller 107 (S12). Similarly, the temperature of the ambient air taken into the second duct 202 from outside is detected by the ambient air sensor 162, and the offset adjustment of the detected temperature is performed in the controller 107 (S13, S14). Similarly, the temperature of the ambient air taken into the third duct 203 from outside is detected by the ambient air sensor 163, and the offset adjustment of the detected temperature is performed in the controller 107 (S15, S16).

Next, based on the temperatures of three locations such as the ducts 201, 202, and 203 after the offset adjustment, for example, the highest temperature is selected in the controller 107 (S17). Then, the comparison determination between the selected highest temperature and the threshold of the temperature protection is performed (S18). When the highest temperature is lower than the threshold of the temperature protection as a result of the determination, the number of rotations of the cooling fans 121 to 127 is set based on the highest temperature (S19). Meanwhile, when the highest temperature is equal to or higher than the threshold of the temperature protection, the shutdown is performed for temperature protection (S20).

Although the comparison determination between the highest temperature and the threshold of the temperature protection is performed here, the comparison determination is not limited to this. For example, the comparison determination may be performed between the temperature difference between the highest temperature and the lowest temperature and the threshold of the temperature protection, or the comparison determination may be performed between the average value of the temperatures of the three locations and the threshold of the temperature protection.

Moreover, though described later (FIG. 28, FIG. 29), the control plates 231, 232, and 233 of the openings 221, 222, and 223 provided in the wall surfaces between the adjacent ducts are controlled based on the temperatures detected by the ambient air sensor 161, the ambient air sensor 162, and the ambient air sensor 163.

### Operation Example 2 of Ambient Air Sensor

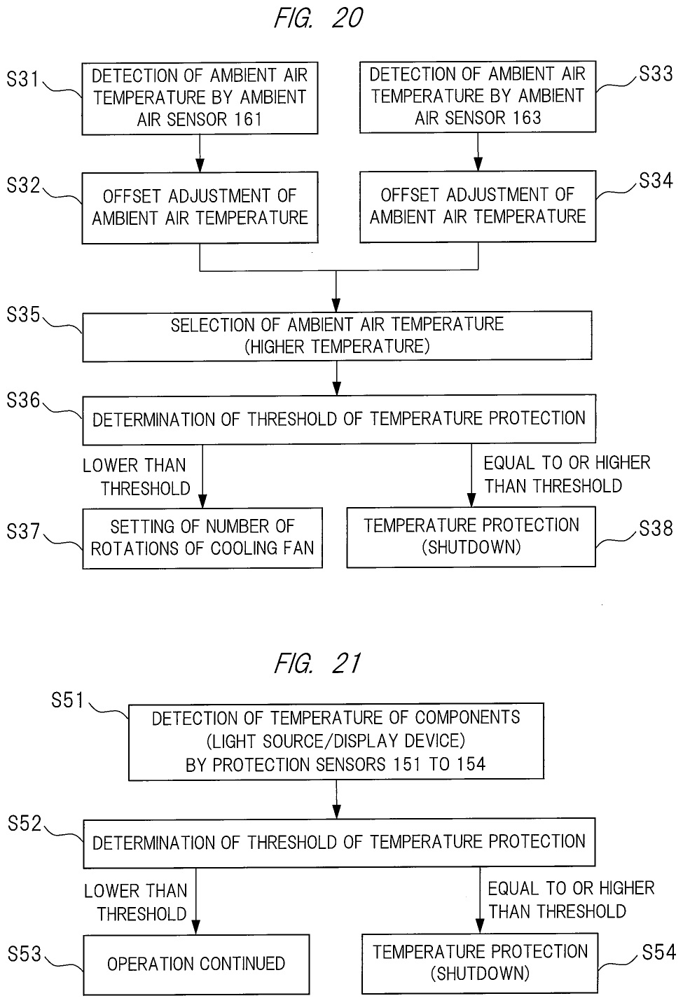

FIG. 20 is a flow diagram showing the operation example 2 of the ambient air sensor of the projection video display apparatus 100 according to the present embodiment. FIG. 20 corresponds to the case where the two ambient air sensors 161 and 163 are provided. Not limited to this, the same is true of the case where the two ambient air sensors 161 and 162 are provided and the case where the two ambient air sensors 162 and 163 are provided.

In the example of FIG. 20, the ambient air sensor 161 and the ambient air sensor 163 are provided. As shown in FIG. 20, the temperature of the ambient air taken into the first duct 201 from outside is detected by the ambient air sensor 161 (S31). Similarly, the temperature of the ambient air taken into the third duct 203 from outside is detected by the ambient air sensor 163 (S33). Then, the offset adjustment of these detected temperatures is performed in the controller 107 (S32, S34).

Next, based on the temperatures of two locations such as the ducts 201 and 203 after the offset adjustment, for example, the higher temperature is selected, and the comparison determination between the selected higher temperature and the threshold of the temperature protection is performed in the controller 107 (S35, S36). When the higher temperature is lower than the threshold of the temperature protection as a result of the determination, the number of rotations of the cooling fans 121 to 127 is set based on the higher temperature (S37). Meanwhile, when the higher temperature is equal to or higher than the threshold of the temperature protection, the shutdown is performed for temperature protection (S38).

### Operation Example of Protection Sensor

FIG. 21 is a flow diagram showing an operation example of the protection sensor of the projection video display apparatus 100 according to the present embodiment.

The protection sensor 151 is the first sensor configured to detect the temperature of the red light source 104. The protection sensor 152 is the first sensor configured to detect the temperature of the green light source 105. The protection sensor 153 is the first sensor configured to detect the temperature of the blue light source 106. The protection sensor 154 is the first sensor configured to detect the temperature of the display device 102. These protection sensors 151 to 154 are disposed near the respective components.

As shown in FIG. 21, the protection sensor 151, the protection sensor 152, the protection sensor 153, and the protection sensor 154 respectively detect the temperatures of components such as the red light source 104, the green light source 105, the blue light source 106, and the display device 102 (S51). The temperatures detected by the protection sensors 151 to 154 are sent to the controller 107 in the projection video display apparatus 100.

Then, the comparison determination between the detected temperatures of the components and the threshold of the temperature protection is performed in the controller 107 (S52). When the detected temperatures of the components are lower than the threshold of the temperature protection as a result of the determination, the operation is continued (S53). Meanwhile, when the detected temperatures of the components are equal to or higher than the threshold of the temperature protection, the shutdown is performed for temperature protection (S54).

Moreover, though described later (FIG. 28, FIG. 29), the control plates 231, 232, and 233 of the openings 221, 222, and 223 provided in the wall surfaces between the adjacent ducts are controlled based on the temperatures detected by the protection sensor 151, the protection sensor 152, the protection sensor 153, and the protection sensor 154.

### Setting Example of Cooling Fan Variable Speed Following Ambient Air Temperature Using Ambient Air Sensor

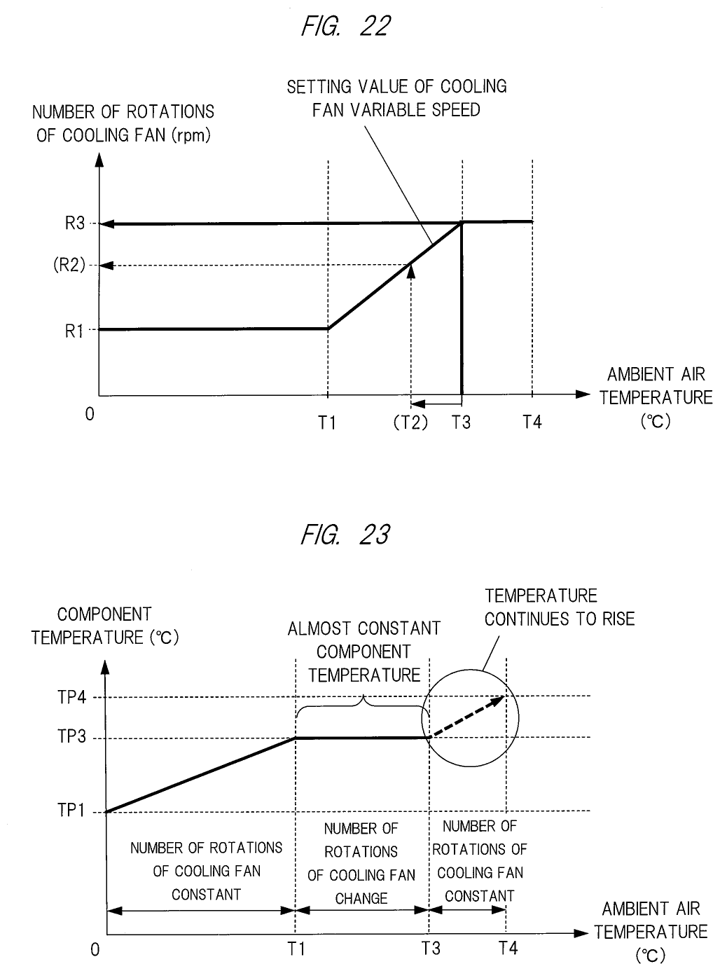

FIG. 22 is an explanatory diagram showing a setting example of a cooling fan variable speed following an ambient air temperature using the ambient air sensor in the projection video display apparatus 100 according to the present embodiment. FIG. 23 is an explanatory diagram showing an example of component temperature change by the ambient air temperature corresponding to FIG. 22.

In FIG. 22, the horizontal axis represents the ambient air temperature (° C.) and the vertical axis represents the number of rotations (rpm) of the cooling fan. For example, when the ambient air temperature is T1 or lower, the number of rotations of the cooling fan is set to a constant value of R1. Further, when the ambient air temperature is in a range from T1 to T3, the number of rotations of the cooling fan is set to a value linearly increasing from R1 to R3. In the range from T1 to T3, there is a variation in the detection of the ambient air temperature T3, and the number of rotations of the cooling fan takes a setting value of R2 between R1 and R3 when the detected value of the ambient air temperature is T2 at the time of the variation. Also, when the ambient air temperature is T3 or higher, the number of rotations of the cooling fan is set to a constant value of R3.

In FIG. 23, the horizontal axis represents the ambient air temperature (° C.) and the vertical axis represents the component temperature (° C.). For example, since the number of rotations of the cooling fan is set to the constant value of R1 when the ambient air temperature is T1 or lower, the component temperature rises from TP1 to TP3. Further, since the number of rotations of the cooling fan is set to the value linearly increasing (changing) from R1 to R3 in the range of the ambient air temperature from T1 to T3, the component temperature is almost constant at TP3. Also, since the number of rotations of the cooling fan is set to a constant value of R3 when the ambient air temperature is T3 or higher, the component temperature continues to rise from TP3 to TP4.

### Control Example of Opening Using Ambient Air Sensor and Protection Sensor

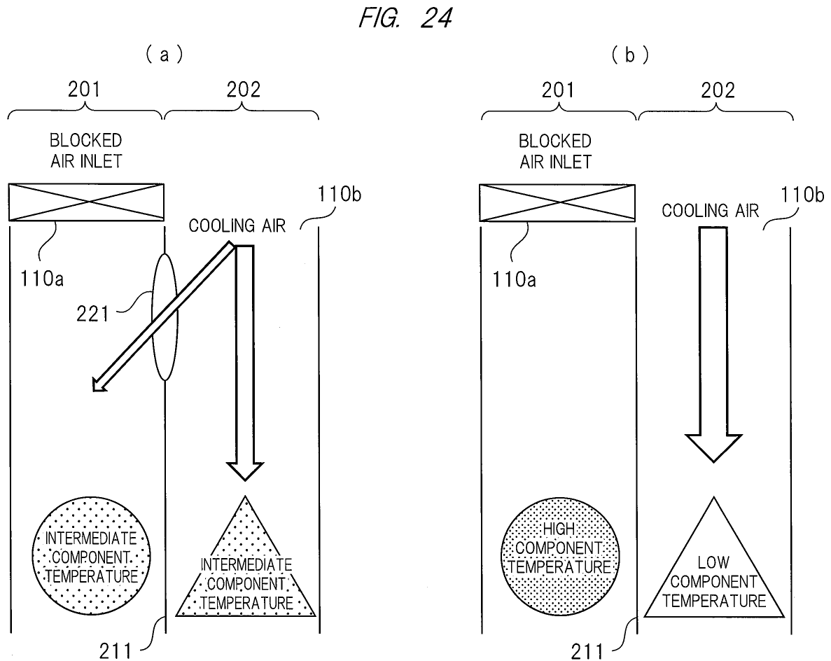

FIG. 24 is an explanatory diagram showing a control example of an opening using the ambient air sensor and the protection sensor in the projection video display apparatus 100 according to the present embodiment. FIG. 24(a) shows the present embodiment and FIG. 24(b) shows the comparative example of the present embodiment.

In the present embodiment, as shown in FIG. 24(a), the first duct 201 and the second duct 202 adjacent to each other have the opening 221 in the wall surface 211 between the first duct 201 and the second duct 202. The opening 221 is provided near (at the position in the range where the cooling air directed from the opening 221 reaches the heat generating member) the heat generating member that generates heat such as an optical system component or an electronic component (the red light source 104, the green light source 105, the blue light source 106, the display device 102, the controller 107, and the power supply unit 108).

When the air inlet 110a of the first duct 210 is blocked as shown in the example of FIG. 24(a), the cooling air flowing out from the opening 221 is directed toward the component in the first duct 201 from the second duct 202. Thus, even when the air inlet 110a of the first duct 201 is blocked, the cooling air can be supplied to the component in the first duct 201, so that it is possible to suppress the rise of the temperature of the component and suppress the decrease in the life.

Meanwhile, in the comparative example of the present embodiment, as shown in FIG. 24(b), no opening is provided in the wall surface 211 between the first duct 201 and the second duct 202 adjacent to each other. Therefore, when the air inlet 110a of the first duct 201 is blocked, the cooling air cannot be supplied to the component in the first duct 201, so that the temperature of the component rises, resulting in the decrease in the lifetime.

Accordingly, when the present embodiment and the comparative example of the present embodiment are compared, the temperature of the component disposed in the first duct 201 becomes relatively higher and the temperature of the component disposed in the second duct 202 is kept low in the comparative example. In this comparative example, the lifetime of the component disposed in the first duct 201 is decreased, resulting in the decrease in the lifetime of the overall projection video display apparatus 100.

Meanwhile, in the present embodiment, the temperature of the component disposed in the first duct 201 and the temperature of the component disposed in the second duct 202 can be set to an intermediate temperature. In the present embodiment, the lifetime of the component disposed in the first duct 201 and the component disposed in the second duct 202 is increased, resulting in the increase in the lifetime of the overall projection video display apparatus 100.

FIG. 25 is an explanatory diagram showing the control example 1 of the opening using the ambient air sensor in the projection video display apparatus 100 according to the present embodiment.

In the control of the openings 221 to 223 using the ambient air sensor 161, the ambient air sensor 162, and the ambient air sensor 163 (FIG. 11 to FIG. 18: cooling structure examples 1 to 8), the control by the feedforward is performed.

As shown in FIG. 25, when there is the temperature rise in the ambient air sensor 161, the ambient air sensor 162, and the ambient air sensor 163 (determination of no blocking of air inlet), the opening control is not performed. The state where the opening control is not performed means the state where the control plates 231, 232, and 233 of the openings 221, 222, and 223 are closed.

When there is the temperature rise in the ambient air sensor 161 and the ambient air sensor 162 and there is no temperature change in the ambient air sensor 163, the cooling structure example 6 is applied. When there is the temperature rise in the ambient air sensor 162 and the ambient air sensor 163 and there is no temperature change in the ambient air sensor 161, the cooling structure example 7 is applied. When there is the temperature rise in the ambient air sensor 161 and the ambient air sensor 163 and there is no temperature change in the ambient air sensor 162, the cooling structure example 8 is applied.

When there is the temperature rise in the ambient air sensor 161 and there is no temperature change in the ambient air sensor 162 and the ambient air sensor 163, the cooling structure example 4 is applied. When there is the temperature rise in the ambient air sensor 162 and there is no temperature change in the ambient air sensor 161 and the ambient air sensor 163, the cooling structure example 1, 3, or 5 is applied. When there is the temperature rise in the ambient air sensor 163 and there is no temperature change in the ambient air sensor 161 and the ambient air sensor 162, the cooling structure example 2 is applied.

When there is no temperature change in the ambient air sensor 161, the ambient air sensor 162, and the ambient air sensor 163 (determination of no blocking of air inlet), the opening control is not performed.

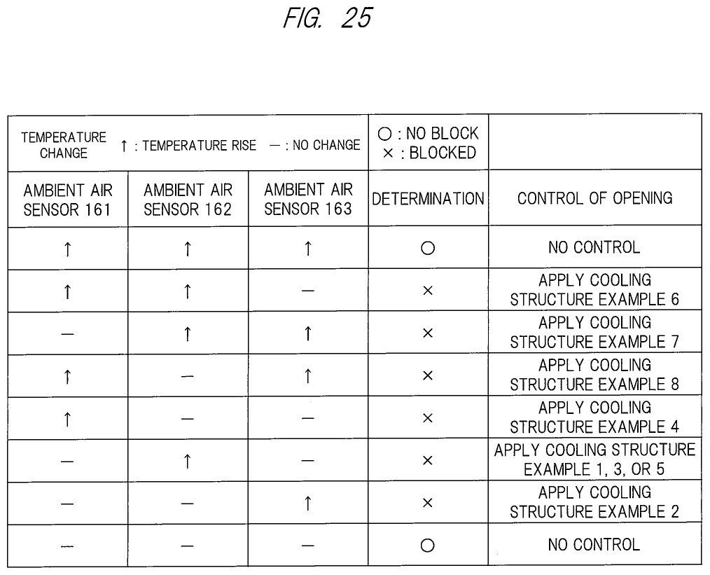

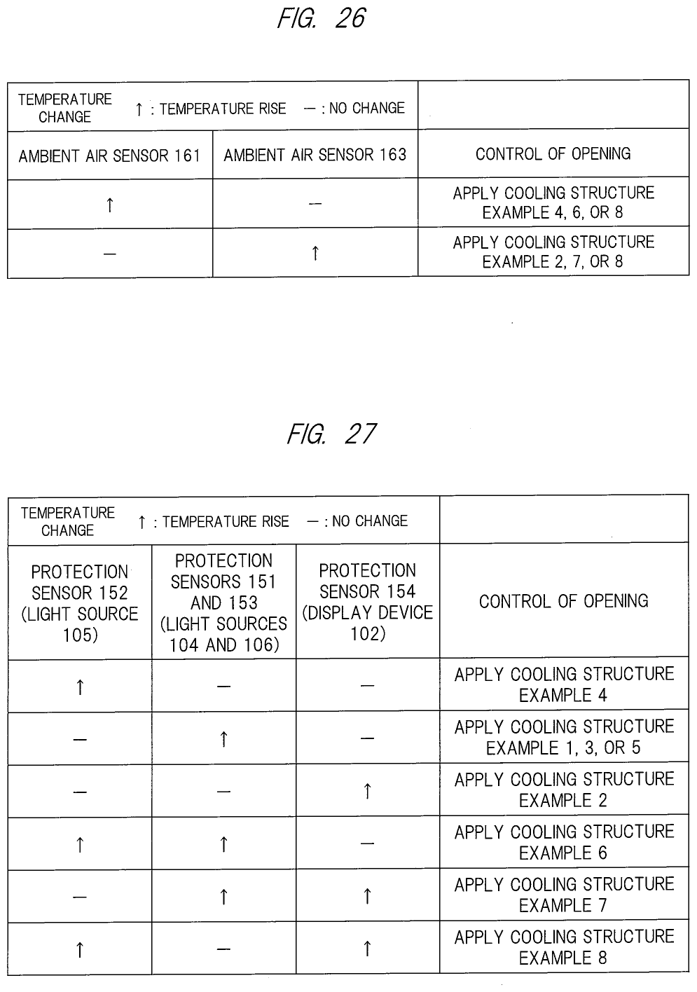

FIG. 26 is an explanatory diagram showing the control example 2 of the opening using the ambient air sensor in the projection video display apparatus 100 according to the present embodiment. FIG. 26 corresponds to the case where the two ambient air sensors 161 and 163 are provided. Not limited to this, the same is true of the case where the two ambient air sensors 161 and 162 are provided and the case where the two ambient air sensors 162 and 163 are provided.

In the control of the openings 221 to 223 using the ambient air sensor 161 and the ambient air sensor 163 (FIG. 11 to FIG. 18: cooling structure examples 1 to 8), the control by the feedforward is performed.

As shown in FIG. 26, when there is the temperature rise in the ambient air sensor 161 and there is no temperature change in the ambient air sensor 163, the cooling structure example 4, 6, or 8 is applied. When there is the temperature rise in the ambient air sensor 163 and there is no temperature change in the ambient air sensor 161, the cooling structure example 2, 7, or 8 is applied.

FIG. 27 is an explanatory diagram showing a control example of the opening using the protection sensor in the projection video display apparatus 100 according to the present embodiment.

In the control of the openings 221 to 223 using the protection sensor 152, the protection sensors 151 and 153, and the protection sensor 154 (FIG. 11 to FIG. 18: cooling structure examples 1 to 8), the control by the feedback is performed.

As shown in FIG. 27, when there is the temperature rise in the protection sensor 152 and there is no temperature change in the protection sensors 151, 153, and 154, the cooling structure example 4 is applied. When there is the temperature rise in the protection sensors 151 and 153 and there is no temperature change in the protection sensors 152 and 154, the cooling structure example 1, 3, or 5 is applied. When there is the temperature rise in the protection sensor 154 and there is no temperature change in the protection sensors 152, 151 and 153, the cooling structure example 2 is applied.

When there is the temperature rise in the protection sensor 152 and the protection sensors 151 and 153 and there is no temperature change in the protection sensor 154, the cooling structure example 6 is applied. When there is the temperature rise in the protection sensors 151, 153, and 154 and there is no temperature change in the protection sensor 152, the cooling structure example 7 is applied. When there is the temperature rise in the protection sensors 152 and 154 and there is no temperature change in the protection sensors 151 and 153, the cooling structure example 8 is applied.

### Shape Example of Control Plate of Opening

FIG. 28 is an explanatory diagram showing the shape example 1 of the control plate of the opening in the projection video display apparatus 100 according to the present embodiment.

As shown in FIG. 28, for example, the opening 221 provided in the wall surface 211 between the first duct 201 and the second duct 202 adjacent to each other has the control plate configured to direct the cooling air to the arbitrary duct (for example, the duct in which the heat generating member whose temperature rises is disposed) and control the air volume thereof based on the result of the detection of the temperature of the heat generating member that generates heat such as an optical system component or an electronic component. The same is true of the opening 222 provided in the wall surface 212 between the second duct 202 and the third duct 203 adjacent to each other.

FIG. 28 corresponds to the case where the two control plates 231 and 232 are provided in the opening 221. In this case, for example, the first control plate 231 configured to open toward the first duct 201 and the second control plate 232 configured to open toward the second duct 202 are provided in the opening 221 in the wall surface 211 between the first duct 201 and the second duct 202. These control plates 231 and 232 are opened and closed by, for example, electric poles 241 and 242 configured to move between one end and the other end of the control plates 231 and 232. The control plates 231 and 232 each have the structure in which the one end thereof is supported by the wall surface 211 and the other end thereof can be opened by the elastic force of a spring 251 or 252 provided between the other end and the wall surface 211.

In the state where the control plates 231 and 232 are closed, the electric poles 241 and 242 are located on the other end side of the control plates 231 and 232. When the control plates 231 and 232 are opened from this state, the electric poles 241 and 242 are moved from the other end side to the one end side of the control plates 231 and 232, so that the other ends of the control plates 231 and 232 are opened by the elastic force of the springs 251 and 252.

FIG. 28(a) shows the state where the first control plate 231 is opened and the second control plate 232 is closed. In the state where the first control plate 231 is opened, the cooling air flowing out from the opening 221 is directed toward the second duct 202 from the first duct 201.

FIG. 28(b) shows the state where the first control plate 231 is closed and the second control plate 232 is opened. In the state where the second control plate 232 is opened, the cooling air flowing out from the opening 221 is directed toward the first duct 201 from the second duct 202.

The air volume of the cooling air to be directed is controlled by the opening degree OP1 of the control plates 231 and 232. The air volume of the cooling air to be directed is large when the opening degree OP1 is large, and the air volume of the cooling air to be directed is small when the opening degree OP1 is small.

FIG. 29 is an explanatory diagram showing the shape example 2 of the control plate of the opening in the projection video display apparatus 100 according to the present embodiment.

FIG. 29 corresponds to the case where the one control plate 233 is provided. In this case, for example, the first control plate 233 configured to open toward the second duct 202 is provided in the opening 223 in the wall surface 212 between the second duct 202 and the third duct 203. The control plate 233 is opened and closed by an electric pole 243 and a spring 253 in the same manner as the case of FIG. 28. For example, the opening degree OP2 of the control plate 233 is smaller than the opening degree OP1 of FIG. 28, and the air volume of the cooling air to be directed is smaller than that of the case of FIG. 28.

### Effect of Present Embodiment

With the projection video display apparatus 100 according to the present embodiment described above, the openings 221 to 223 are provided in the wall surfaces 211 and 212 between the plurality of ducts 201 to 203 adjacent to each other. Therefore, even when any of the air inlets 110a to 110c of a certain duct among the plurality of ducts 201 to 203 is blocked, the cooling air path to the ducts 201 to 203 in which the air inlets 110a to 110c are blocked can be secured.

Further, the cooling air flowing out from the openings 221 to 223 can be directed toward the red light source 104, the green light source 105, the blue light source 106, the display device 102, the controller 107, or the power supply unit 108.

Moreover, since the openings 221 to 223 have the control plates 231 to 233, it is possible to direct the cooling air to the arbitrary duct and control the air volume thereof based on the result of the detection of the temperature of the red light source 104, the green light source 105, the blue light source 106 or the display device 102.

Also, by disposing the red light source 104, the green light source 105, the blue light source 106, the display device 102, the controller 107, or the power supply unit 108 on the downstream side of the openings 221 to 223, the temperature of each of these components can be managed.

The effects other than the foregoing representative effects are as described in each section in the present embodiment above.

In the foregoing, the invention made by the inventors of the present invention has been described based on the embodiment. However, it is needless to say that the present invention is not limited to the foregoing embodiment and can be modified in various ways within the scope of the invention.

Note that the present invention is not limited to the above-described embodiment and includes various modifications. For example, the embodiment above has described the present invention in detail for easy understanding, and the present invention is not always limited to that including all of the described configurations.

An example of the modifications has the following configuration in an aspect of the case including light sources of three colors such as the red light source, the green light source, and the blue light source as the plurality of heat generating members. The first duct is configured to cool the heat from the first heat generating member among the plurality of heat generating members, and the first heat generating member includes the light source of one color among the light sources of three colors. The second duct is configured to cool the heat from the second heat generating member among the plurality of heat generating members, and the second heat generating member includes at least another light source of one color among the light sources of three colors. The third duct is configured to cool the heat from the third heat generating member among the plurality of heat generating members, and the third heat generating member includes the display device.

Another example of the modifications has the following configuration in an aspect of the case including light sources of three colors such as the red light source, the green light source, and the blue light source, the display device, the controller configured to drive the red light source, the green light source, the blue light source, and the display device, and the power supply unit configured to supply power to the controller as the plurality of heat generating members. The first duct is configured to cool the heat from the first heat generating member among the plurality of heat generating members, and the first heat generating member includes the light source of one color among the light sources of three colors, the controller configured to drive the light source of one color among the light sources of three colors, and the power supply unit. The second duct is configured to cool the heat from the second heat generating member among the plurality of heat generating members, and the second heat generating member includes at least another light source of one color among the light sources of three colors, the controller configured to drive at least the light source of one color among the light sources of three colors, and the power supply unit. The third duct is configured to cool the heat from the third heat generating member among the plurality of heat generating members, and the third heat generating member includes the display device.

Also, the other configuration may be added to a part of the configuration of the embodiment described above, and a part of the configuration of the embodiment described above may be deleted or replaced with the other configuration. For example, the cooling structure example may be changed by combining with other cooling structure example as appropriate. Also, the number of openings and the position of the openings may be changed in various ways within the scope of the present invention.

### REFERENCE SIGNS LIST

100: projection video display apparatus
101: projection optical system
102: display device
103: illumination optical system
103a: parallel portion
103b: right-angle portion
104, 105, 106: light source
107: controller
108: power supply unit
110: housing
110a, 110b, 110c: air inlet
110b, 110e, 110f: air outlet
121, 122, 123, 124, 125, 126, 127: cooling fan
131: cooling module
141, 142, 143: heat pipe
141a, 142a, 143a: heat receiving portion
141b, 142b, 143b: pipe portion
141c, 142c, 143c: fin portion
151, 152, 153, 154: protection sensor
161, 162, 163: ambient air sensor
201, 202, 203: duct
211, 212: wall surface
221, 222, 223: opening
231, 232, 233: control plate
241, 242, 243: electric pole
251, 252, 253: spring
301, 301a, 301b, 301c, 301d, 302, 302a, 302b, 302c, 302d, 303, 303a, 303b, 303c, 303d: cooling air

1. A projection video display apparatus comprising:
a heat generating member that generates heat such as an optical system component or an electronic component;
a plurality of cooling fans configured to cool heat from the heat generating member; and
a plurality of ducts to be cooling air paths each having at least one of the plurality of cooling fans stored therein, at least two of the ducts being adjacent to each other,
wherein the ducts adjacent to each other have an opening in a wall surface between the adjacent ducts.

2. The projection video display apparatus according to claim 1,
wherein the opening of the adjacent ducts is provided near the heat generating member, and
a cooling air flowing out from the opening is directed toward the heat generating member.

3. The projection video display apparatus according to claim 1,
wherein the opening of the adjacent ducts has a control plate configured to direct a cooling air to an arbitrary duct and control air volume thereof based on a result of detection of a temperature of the heat generating member.

4. The projection video display apparatus according to claim 1,
wherein at least one component of the heat generating member whose temperature needs to be managed is disposed on a downstream side of the opening.

5. The projection video display apparatus according to claim 1,
wherein the heat generating member includes a plurality of heat generating members,
the plurality of ducts include a first duct, a second duct adjacent to the first duct, and a third duct adjacent to the second duct,
the first duct stores first, second, and third cooling fans configured to cool heat from a first heat generating member among the plurality of heat generating members, the first cooling fan is disposed at a side of an air inlet of the first duct, the second cooling fan is disposed at a side of an air outlet of the first duct, and the third cooling fan is disposed between the air inlet and the air outlet of the first duct,
the second duct stores fourth, fifth, and sixth cooling fans configured to cool heat from a second heat generating member among the plurality of heat generating members, the fourth cooling fan is disposed at a side of an air inlet of the second duct, the fifth cooling fan is disposed at a side of an air outlet of the second duct, and the sixth cooling fan is disposed between the air inlet and the air outlet of the second duct,
the third duct stores a seventh cooling fan configured to cool heat from a third heat generating member among the plurality of heat generating members, and the seventh cooling fan is disposed at a side of an air inlet of the third duct, and
the opening is provided in a wall surface between the first duct and the second duct, a wall surface between the second duct and the third duct, or each of the wall surfaces.

6. The projection video display apparatus according to claim 5,
wherein a first opening is provided in the wall surface between the second duct and the third duct, and
when the air inlet of the second duct is blocked, a cooling air flowing out from the first opening is directed toward the second duct from the third duct.

7. The projection video display apparatus according to claim 5,
wherein a second opening is provided in the wall surface between the second duct and the third duct, and
when the air inlet of the third duct is blocked, a cooling air flowing out from the second opening is directed toward the third duct from the second duct.

8. The projection video display apparatus according to claim 5,
wherein a third opening is provided in the wall surface between the first duct and the second duct, and
when the air inlet of the second duct is blocked, a cooling air flowing out from the third opening is directed toward the second duct from the first duct.

9. The projection video display apparatus according to claim 5,
wherein a third opening is provided in the wall surface between the first duct and the second duct, and
when the air inlet of the first duct is blocked, a cooling air flowing out from the third opening is directed toward the first duct from the second duct.

10. The projection video display apparatus according to claim 5,
wherein a third opening is provided in the wall surface between the first duct and the second duct,
a first opening is provided in the wall surface between the second duct and the third duct, and
when the air inlet of the second duct is blocked, cooling airs flowing out from the third opening and the first opening are directed toward the second duct from the first duct and the third duct.

11. The projection video display apparatus according to claim 5,
wherein a third opening is provided in the wall surface between the first duct and the second duct,
a first opening is provided in the wall surface between the second duct and the third duct, and
when the air inlet of the first duct and the air inlet of the second duct are blocked, a cooling air flowing out from the first opening is directed toward the second duct from the third duct and a cooling air flowing out from the third opening is further directed toward the first duct from the second duct.

12. The projection video display apparatus according to claim 5,
wherein a third opening is provided in the wall surface between the first duct and the second duct,
a second opening is provided in the wall surface between the second duct and the third duct, and
when the air inlet of the second duct and the air inlet of the third duct are blocked, a cooling air flowing out from the third opening is directed toward the second duct from the first duct and a cooling air flowing out from the second opening is further directed toward the third duct from the second duct.

13. The projection video display apparatus according to claim 5,
wherein a third opening is provided in the wall surface between the first duct and the second duct,
a second opening is provided in the wall surface between the second duct and the third duct, and
when the air inlet of the first duct and the air inlet of the third duct are blocked, a cooling air flowing out from the third opening is directed toward the first duct from the second duct and a cooling air flowing out from the second opening is further directed toward the third duct from the second duct.

14. The projection video display apparatus according to claim 1,
wherein the heat generating member includes a plurality of heat generating members,
the plurality of ducts include a first duct, a second duct adjacent to the first duct, and a third duct adjacent to the second duct,
the plurality of heat generating members include light sources of three colors such as a red light source, a green light source, and a blue light source,
the first duct is configured to cool heat from a first heat generating member among the plurality of heat generating members and the first heat generating member includes a light source of one color among the light sources of three colors,
the second duct is configured to cool heat from a second heat generating member among the plurality of heat generating members and the second heat generating member includes at least another light source of one color among the light sources of three colors, and
the third duct is configured to cool heat from a third heat generating member among the plurality of heat generating members and the third heat generating member includes a display device.

15. The projection video display apparatus according to claim 1,
wherein the heat generating member includes a plurality of heat generating members,
the plurality of ducts include a first duct, a second duct adjacent to the first duct, and a third duct adjacent to the second duct,
the plurality of heat generating members include light sources of three colors such as a red light source, a green light source, and a blue light source, a display device, a controller configured to drive the red light source, the green light source, the blue light source, and the display device, and a power supply unit configured to supply power to the controller,
the first duct is configured to cool heat from a first heat generating member among the plurality of heat generating members and the first heat generating member includes a light source of one color among the light sources of three colors, the controller configured to drive the light source of one color among the light sources of three colors, and the power supply unit,
the second duct is configured to cool heat from a second heat generating member among the plurality of heat generating members and the second heat generating member includes at least another light source of one color among the light sources of three colors, the controller configured to drive the light source of one color among the light sources of three colors, and the power supply unit, and
the third duct is configured to cool heat from a third heat generating member among the plurality of heat generating members and the third heat generating member includes the display device.

16. The projection video display apparatus according to claim 15, further comprising:
a plurality of first sensors configured to detect temperatures of the optical system component and the electronic component; and
a plurality of second sensors configured to detect a temperature of cooling air taken from outside,
wherein the first sensors include a plurality of sensors configured to detect temperatures of the red light source, the green light source, the blue light source, and the display device,
the second sensors include a plurality of sensors configured to detect temperatures of an air inlet of the first duct, an air inlet of the second duct, and an air inlet of the third duct, and
a control plate of the opening is controlled based on the temperatures detected by the first sensors and the second sensors.
